(19) United States
(12) Patent Application Publication
(10) Pub. No.: US 2009/0281836 A1
(43) Pub. Date: Nov. 12, 2009

(54) PERSONAL MEDICAL RECORD SYSTEM

(75) Inventor: Donald Velarde, Mesa, AZ (US)

Correspondence Address: KEITH L. JENKINS, 2222 NORTH MCQUEEN ROAD #2069, CHANDLER, AZ, 85225, US

(73) Assignee: Portable Health Record Services, LLC, Mesa, AZ (US)

(21) Appl. No.: 12/406,302

(22) Filed: Mar. 18, 2009

Related U.S. Application Data
(60) Provisional application No. 61/052,267, filed on May 11, 2008.

(51) Int. Cl. G06Q 50/00; H04L 9/32; G09B 19/00

(52) U.S. Cl. 705/3; 705/51; 705/2; 434/118; 707/102; 711/115; 711/E12.092; 707/E17.044

(57) ABSTRACT

A business method for providing improved portable health care records management that is HIPAA compliant and legally reliable from the physician's perspective. The method provides service for providing a USB portable medical records database to a hospital patient in a USB device with multiple layers of security. The USB device and first and second softwares for implementing updates of the USB portable medical records database are provided. A first software resident on the USB device auto-runs a resident database of patient medical records and provides security and HMI functions. Second software resides on a business computer linked to the hospital medical records database for acquiring, sorting, and storing medical records on the USB device. A discharge service includes creating a USB portable medical records database for a patient being discharged, and may optionally include reviews of the records for compliance with medical and insurance standards. Only physician-dictated records are stored.

### RELATIONSHIP TO OTHER APPLICATIONS

The present application claims the benefit of U.S. provisional patent application Ser. No. 61/052,267 filed May 11, 2008 to one common inventor for an IMPROVED PERSONAL MEDICAL RECORD SYSTEM, which is incorporated herein by reference.

### FIELD OF THE INVENTION

The present invention generally relates to health records management systems, and more particularly relates to medical records systems that provide patients with their own portable electronic copy of their own health care records. The present invention specifically relates to a portable medical records database that is focused on physician-to-physician communication.

### BACKGROUND OF THE INVENTION

Difficulties in gaining timely access to a patient's medical records, especially in emergency situations, can lead to uninformed medical procedures for the patient, with potentially fatal consequences. Often, a patient does not know what records are available or where to obtain them. It has been recognized that advances in portable memory devices, such as USB compatible USB devices, creates the opportunity for a large amount of data, such as a patient's medical records, to be possessed and carried by the patient. See, for example, US Patent Publication 20030097351 A1 by Rothschild, et al., published May 5, 2003 (abandoned) for an enthusiastic attempt.

Medical records may be mislaid, misfiled, or scattered among many care providers, creating additional problems for health care providers. Yet another serious problem is a lack of organization of the records, making it time-consuming to find the required information.

The inventor has realized that difficulties with previous systems reflect a lack of appreciation of the legal implications of health records maintenance. For example, the Health Insurance Portability and Accountability Act (HIPAA) imposes security requirements, which have not been addressed by some inventors. Those who allow patient access to the medical records on the USB device, for example, may not be in compliance with HIPAA. In addition, the tort law implications of allowing patients free access to medical records that an emergency room doctor may have to rely on are quite serious. If the doctor has no reasonable belief that the records he has before him are the products only of health care professionals, he has no reasonable basis for relying on them. The ability of an emergency room physician to reasonably rely on the records is crucial to the success of the system.

Personal medical records system that have been proposed fall into two broad categories. In the first category are centralized storage systems that store the patient's information on servers or associated data storage devices on the internet, world-wide web, or similar information distribution system. Some of the centralized storage systems require the patient to carry or wear an electronic key, of any of various forms, that is used as an access key to the patient's centrally stored data. For example, U.S. Pat. No. 6,988,075 B1 issued to Hacker on Jan. 17, 2006 for a PATIENT-CONTROLLED MEDICAL INFORMATION SYSTEM AND METHOD discloses a patient-key-access centralized storage system over the internet. Hacker does not limit the records to those created by physicians. U.S. Pat. No. 7,039,628 B2 issued to Logan, Jr. on May 2, 2006 for a PORTABLE HEALTH CARE HISTORY INFORMATION SYSTEM is also a patient-key-access centralized storage system over the internet that allows emergency medical data to be accessed without a password. Logan does not limit the records to those created by physicians.

One disadvantage of centralized storage systems is that the internet, world-wide web, or the like, may not be available in precisely the kind of emergency situation in which the data would be most important. For example, after hurricane Katrina, internet access in the disaster area was significantly disrupted. A second disadvantage of centralized storage systems is that, despite best efforts, centralized storage sites may be hacked, and because of the large amount of data contained therein, may be worthwhile hacker targets. U.S. Pat. No. 6,347,329 B1 issued to Evans on Feb. 12, 2002 for ELECTRONIC MEDICAL RECORDS is such a centralized storage system that receives records, images, audio files, and other data from any “authorized healthcare provider”. Evans does not limit the records to those created by physicians. U.S. Pat. No. 6,747,561 B1 issued to Reeves on Jun. 8, 2004 for a BODILY WORN DEVICE FOR DIGITAL STORAGE AND RETRIEVAL OF MEDICAL RECORDS AND PERSONAL IDENTIFICATION describes a wireless device that is worn as jewelry and stores medical records. The apparatus for accessing the data wirelessly is not as broadly available as USB ports. Reeves does not limit the records to those created by physicians.

In the second category are distributed storage systems. Typically, the distributed data systems enable the patient to keep his or her own records in his or her own personal possession. Some distributed storage systems use personal computing devices that include processors, viewing screens, and data storage, and can bring up the medical records for viewing or transfer them to another computer for viewing. Distributed storage systems of primary interest here are systems that use personal devices for data storage and rely on other computers for the processing and display functions. For example, systems that use USB devices for storage of data and related software are distributed storage systems.

U.S. Pat. No. 6,523,009 B1 issued to Wilkins on Feb. 18, 2003 (expired) for an INDIVIDUALIZED PATIENT ELECTRONIC MEDICAL RECORDS SYSTEM provides a distributed storage system that allows a patient complete access to the stored data and provides “access to the information by medical care providers and/or insurance providers and administrators, particularly emergency medical care providers, is not impeded by password or other protective means”. Wilkins does not limit the records to those created by physicians, although Wilkins does isolate the data that may be input by medical professionals from patient write access. Wilkins does not disclose a method of doing business that involves training and supervision.

US Patent Publication 20030097351 A1 by Rothschild, et al., published May 22, 2003 (abandoned) for a PORTABLE PERSONAL MEDICAL IMAGE STORAGE DEVICE provides data storage on a USB device and allows the patient to “update and/or backup the files using a computer with a universal port or interface”. Patient access to the medical data can be problematic for the legal reasons discussed above. Rothschild discloses the use of a database on the portable USB device that can be updated by any authorized user, including the patient. Rothschild does not limit the records to those created by physicians. Rothschild does not disclose a method of doing business that involves training and supervision.

US Patent Publication 20070265884 A1 by Lubell, et al., published Nov. 15, 2007 for a PORTABLE MEMORY DEVICE CONFIGURED TO STORE PERSON'S MEDICAL INFORMATION (hereinafter Lubell '884) uses a USB device with a database and viewing software that automatically runs when inserted into a USB socket. The patient has access to the files. Lubell prevents the alteration of the stored information but allows anyone with a password to append amendments to it from a generic host. Lubell 884's method does not provide for deleting medical records that are erroneously entered. Lubell '884 provides for a centralized, internet-accessible data recovery center for providing a backup copy. Lubell '884 does not limit the records to those created by physicians. Lubell '884 does not disclose a method of doing business that involves training and supervision. All of Lubell 884's software, including updating software, is resident on the portable device. Lubell '884 has a provision for emergency access via an 800 telephone number call to a customer service center.

US Patent Publication 20080015904 A1 by Lubell, et al., published Jan. 17, 2008 for MAINTAINING PERSON'S MEDICAL HISTORY IN SELF-CONTAINED PORTABLE MEMORY DEVICE (hereinafter Lubell '904) relies on an identical specification to Lubell '884, but adds claims detailing in greater clarity that all of the storing, updating, and accessing software is resident in the portable device. Lubell '904's approach more clearly illustrates that Lubell '884, '904, and '905 require the user to get personnel at his doctor's office to insert a strange USB device, carrying whatever computer viruses, inappropriate user inputs, and errors it may have picked up along the way, into the doctor's business computer, with access to patient medical records provided by software on the USB device. Not likely.

US Patent Publication 20080015905 A1 by Lubell, et al., published Jan. 17, 2008 for MAINTAINING PERSON'S MEDICAL HISTORY IN SELF-CONTAINED PORTABLE MEMORY DEVICE (hereinafter Lubell '905) relies on an identical specification to Lubell '884, but adds claim language for the backup method. The lack of a file deletion method, and the requirement to connect to a host computer a strange (from the host computer point of view) USB device that carries software for acquiring records off the host computer, remain.

Canadian Published Patent Application CA 2545131 by Hartman, et al., published Oct. 27, 2006 for a PERSONAL INFORMATION KEY WITH AUTO APPLICATION EXECUTION (hereinafter Hartman '131), discloses a portable USB device that holds 1) medical information in a first storage area, 2) a program product generated by a centralized medical records repository in a second storage area, and 3) added information in a third storage area. The program product, entirely and solely resident on the USB device, provides medical data acquisition functionality through communications interfaces. The program product “prevents” altering of the stored medical information, by using an area of the device marked as non-rewritable. The data acquisition software, decryption, and communications software is all on the USB device. Hartman '131 can receive software updates to the program product over the internet.

US Patent Publication 20070170239 A1 to Hartman et al., for a SELF CONTAINED PORTABLE DATA MANAGEMENT KEY published Jul. 26, 2007 (hereinafter Hartman '239) discloses a similar system to Hartman '131. Like Hartman '131, Hartman '239 resides data acquisition, decryption, and communication software on the USB device. Also similar, Hartman '239 stores image data and data by medical professionals that may not be physicians.

Accordingly, in order to solve the above-mentioned problem and meet related needs, the present inventor has determined that it is desirable to provide a business method and apparatus for managing a distributed storage portable health record systems that meets or exceeds HIPAA requirements, and that creates a product that emergency room physicians, as well as other health care professionals, may reasonably rely upon.

### BRIEF SUMMARY OF THE INVENTION

An improved personal medical records system including the combination of steps of: providing first software for providing database and security on a USB device; providing second software for retrieving, sorting, and securely storing medical records data onto the USB device; installing the second software on a computer linked to a hospital computer system used for storing and managing medical records wherein: the medical records include documents; the documents include document identifiers; the documents are sortable into predetermined categories responsive to the document identifier and to a patient identifier of a particular patient; and the sorted document is thereafter associated with the category and such particular patient. The system further includes training hospital personnel to use the second software for securely storing the documents in the USB device; preparing the USB device by installing the first software onto the USB device; providing the prepared USB device to the hospital; supervising such trained personnel of the hospital in storing the documents in the prepared USB device, wherein the documents stored in the database of the prepared USB device includes documents authored by a physician. The system further includes supervising such trained personnel of the hospital in providing to such particular patient, when such particular patient is discharged from the hospital, a discharge kit including: the prepared USB device having the stored documents; an emergency card providing emergency contact information and instructions for emergency use of the prepared USB device; and either a wallet or a piece of jewelry able to assist in carrying the prepared USB device and the emergency card; and verifying that such particular patient's primary care physician has received said at least one document.

The improved personal medical records system, wherein the first software includes software able to: provide password-protected access to the documents stored in the prepared USB device; provide 256-bit encryption of the document stored in the prepared USB device; provide automatic deletion of the document on the prepared USB device after six consecutive failed password attempts; and display on a computer monitor the documents stored in the prepared USB device, responsive to entry of a password when the prepared USB device is coupled to a USB port associated with the computer monitor. That improved personal medical records system, wherein the first software is further able to display the document responsive to selection, by a user of the computer, of the category associated with the document. That improved personal medical records system, wherein a particular category of the categories includes an emergency medicine category and further wherein the emergency medicine category is a uniquely accessible category of the document stored on the prepared USB device.

The improved personal medical records system, wherein the second software includes software able to: retrieve, responsive to entry of such particular patient's identification information, the documents associated with such particular patient from the hospital computer; sort, responsive to the document identifier and to the predetermined category, the document associated with such particular patient; and store the sorted documents associated with such particular patient in the database of the prepared USB device.

The improved personal medical records system, wherein the prepared USB device includes a plurality of prepared USB devices, the improved personal medical records system further including the step of charging a fee to the hospital based on the number of the plurality of prepared USB devices provided to the hospital.

The improved personal medical records system, wherein the document consists of a document created by dictation.

The improved personal medical records system, further including the step of reviewing the document for compliance with either a medical standard or an insurance standard.

The improved personal medical records system, wherein the training includes initial training and/or continuing education; wherein the training is not provided for each particular USB device to be provided.

The improved personal medical records system, wherein the hospital personnel are subcontractors to the hospital.

The improved personal medical records system, wherein the second software includes a database program able to enable updating of the medical record stored in the prepared USB device by the process of: reading out the medical record from the prepared USB device; rebuilding the database with a combination of the read-out medical record and additional documents; and storing the rebuilt database in the prepared USB device.

The improved personal medical records system, wherein: the second software includes software able to build a USB database for the documents outside of the USB device; the database built outside of the USB device includes the documents previously stored on the USB device; and the second software includes software able to store in the USB device the database built outside of the USB device.

An improved personal medical records system including the combination of steps of: providing first software for providing database and security on a USB device; providing second software for retrieving, sorting, and securely storing medical records data onto the USB device; installing the second software on a computer linked to a hospital computer system used for storing and managing medical records wherein: the medical records data comprise documents; the documents include document identifiers; the documents are sortable into predetermined categories responsive to the document identifier; and the sorted document is associated with a category; training hospital personnel to use the second software for securely storing the documents in the USB device, wherein: the documents include documents associated with a particular patient; and the document includes documents dictated by physician; preparing the USB device by installing the first software onto the USB device; providing the prepared USB device to the hospital, wherein the training is not provided for each particular prepared USB device. The system further includes supervising such trained personnel of the hospital in storing the documents in the prepared USB device; supervising such trained personnel of the hospital in providing to such particular patient, when such particular patient is discharged from the hospital, a discharge kit including: the prepared USB device having the stored documents; an emergency card providing emergency contact information and instructions for emergency use of the prepared USB device; and a wallet or a piece of jewelry able to assist in carrying the prepared USB device and the emergency card. The system further includes verifying that such particular patient's primary care physician has received said at least one document.

The improved personal medical records system, wherein the first software includes software able to: provide password-protected access to the documents stored in the USB device; provide 256-bit encryption of the document stored in the USB device; provide automatic deletion of the document on the USB device after six consecutive failed password attempts; and display, when coupled to a USB port and responsive to entry of password, the documents stored in the prepared USB device. That improved personal medical records system, wherein the first software is further able to display the documents responsive to user selection of the category associated with the document. That improved personal medical records system, wherein a particular category of the categories includes an emergency medicine category and further wherein the emergency medicine category includes a uniquely accessible category of the documents stored on the prepared USB device.

The improved personal medical records system, wherein the prepared USB device includes a plurality of prepared USB devices, the improved personal medical records system further including the step of charging a fee to the hospital based on the number of the plurality of prepared USB devices provided to the hospital.

The improved personal medical records system, wherein the second software includes software able to: retrieve, responsive to entry of such particular patient's identification information, the documents associated with such particular patient from the hospital computer; sort, responsive to the document identifier and to the predetermined category, the documents associated with such particular patient; and store the document associated with such particular patient in the prepared USB device.

The improved personal medical records system, further including the step of reviewing the document for compliance with a medical standard and/or an insurance standard.

An improved personal medical records system including the combination of steps of: providing first software for providing database and security on a USB device; providing second software for retrieving, sorting, and securely storing medical records data onto the USB device; installing the second software on a computer linked to a hospital computer system used for storing and managing medical records wherein: the medical records data comprise documents; the documents include document identifiers; the documents are sortable into predetermined categories responsive to the document identifier; and the sorted documents are associated with a category. The system further includes training hospital personnel to use the second software for securely storing the documents in the USB device, wherein: the documents includes documents associated with a particular patient; and the documents consist of documents dictated by physicians; wherein the training includes initial training; and continuing education and wherein the training is not provided for each particular USB device to be prepared. The system further includes preparing the USB device by installing the first software onto the USB device; providing a plurality of the prepared USB devices to the hospital and charging a fee to the hospital based on the number of prepared USB devices provided to the hospital; supervising such trained personnel of the hospital in storing the documents in the prepared USB device; supervising such trained personnel of the hospital in providing, to such particular patient when such particular patient is discharged from the hospital, a discharge kit including: the prepared USB device having the stored documents; an emergency card providing emergency contact information and instructions for emergency use of the prepared USB device; and either a wallet or a piece of jewelry able to assist in carrying the prepared USB device and the emergency card; and verifying that such particular patient's primary care physician has received said at least one document.

### BRIEF DESCRIPTION OF THE DRAWINGS

The present invention will hereinafter be described in conjunction with the following drawing figures, wherein like numerals denote like elements, and

FIG. 1 is a process chart illustrating a business process for providing an improved personal medical records system, according to an exemplary embodiment of the present invention;

FIG. 2 is a process chart illustrating a business process for providing an improved personal medical records system, according to another exemplary embodiment of the present invention;

FIG. 3 is a process chart illustrating a business process for providing an improved personal medical records system, according to yet another exemplary embodiment of the present invention;

FIG. 4 is a process chart illustrating a detail of the business process for providing an improved personal medical records system of FIG. 1, according to exemplary embodiments of the present invention;

FIG. 5 is a process chart illustrating another detail of the business process for providing an improved personal medical records system of FIG. 1, according to exemplary embodiments of the present invention;

FIG. 6 is a process chart illustrating yet another detail of the business process for providing an improved personal medical records system of FIG. 1, according to exemplary embodiments of the present invention;

FIG. 7 is a process chart illustrating a detail of the detail in FIG. 6 of the business process for providing an improved personal medical records system of FIG. 1, according to an exemplary embodiment of the present invention;

FIG. 8 is a process chart illustrating still yet another detail of the business process for providing an improved personal medical records system of FIG. 1, according to exemplary embodiments of the present invention;

FIG. 9 is a process chart illustrating still yet another detail of the business process for providing an improved personal medical records system of FIG. 1, as an alternative to the method shown in FIG. 8, according to exemplary embodiments of the present invention;

FIG. 10 is a process chart illustrating the business process for providing an improved personal medical records system, according to an alternate exemplary embodiment of the present invention;

FIG. 11 is a process chart illustrating another detail of the business process for providing an improved personal medical records system of FIG. 1, according to an exemplary embodiment of the present invention;

FIG. 12 is a block diagram of a computer apparatus for implementing the business process for providing an improved personal medical records system of FIG. 1, according to an exemplary embodiment of the present invention;

FIG. 13 is a block diagram of a portable health record media for implementing the business process for providing an improved personal medical records system of FIG. 1, according to an exemplary embodiment of the present invention;

FIG. 14 is a block diagram illustrating a novel pattern of organization for emergency medicine data used in the business process for providing an improved personal medical records system of FIG. 1, according to an exemplary embodiment of the present invention;

FIG. 15 is a process diagram illustrating an improved personal medical records system, according to a preferred exemplary embodiment of the present invention;

FIG. 16 is a block diagrammatic view illustrating the prepared USB device of the improved personal medical record system being used in a personal computer;

FIG. 17 is a block diagrammatic view illustrating an implementation of the improved personal medical record system, according to an exemplary embodiment of the present invention;

FIG. 18 is a process diagram further illustrating an improved personal medical records system, according to a preferred exemplary embodiment of the present invention;

FIG. 19 is a process diagram further illustrating some salient features of an improved personal medical records system, according to a preferred exemplary embodiment of the present invention;

FIG. 20 is a process diagram of some salient features of the prior art disclosure of Lubell;

FIG. 21 is a process diagram of some salient features of the prior art disclosure of Wilkins;

FIG. 22 is a process diagram of some salient features of the prior art disclosure of Rothschild;

FIG. 23 is a process diagram of some salient features of the prior art disclosure of Hartman;

FIG. 24 is a process diagram of some salient features of another prior art disclosure of Hartman;

FIG. 25 is a process diagram of some salient features of the prior art disclosures of Hacker, Logan, and Evans; and

FIG. 26 is a process diagram of some salient features of the prior art disclosure of Reeves.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the drawings.

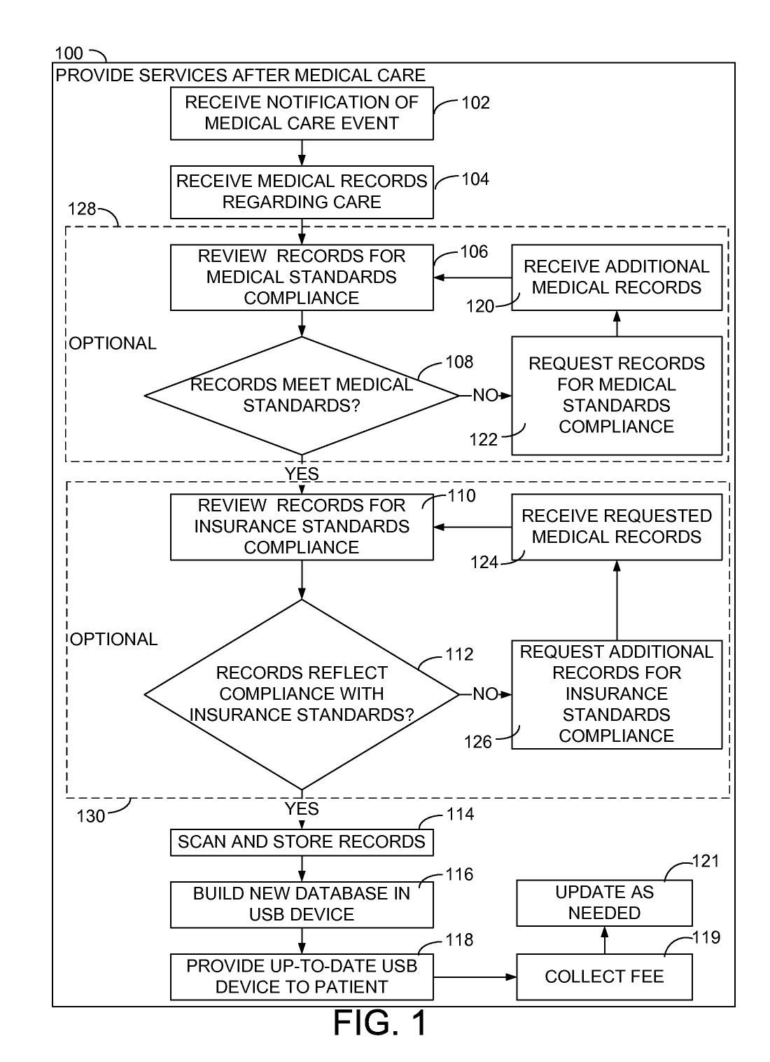

FIG. 1 is a process chart illustrating a business process for providing an improved personal medical records system 100, according to an exemplary embodiment of the present invention. The improved personal medical records system 100 includes a method of doing business. In the exemplary embodiment of the business method, the process begins when the business receives notification 102 of a medical care event that has generated a medical record. The notification 102 may be through the patient, the patient's representative, such as an emergency contact, or through the health care provider, preferably a hospital. The notification step 102 initiates efforts to obtain copies of the medical records, such as obtaining a records release from the patient and notifying the health care provider that the records are released and where to send them. A patient who has a subscription to the services provided by the business may have forms, provided by the business, to provide to health care providers whenever an event that generates medical records occurs. In the exemplary business system 100, medical records are received by the business only from licensed health care providers and licensed health care facilities. In a particular preferred embodiment, the medical records consist only of documents dictated by physicians. Records received from the patient directly are marked in the database to so indicate.

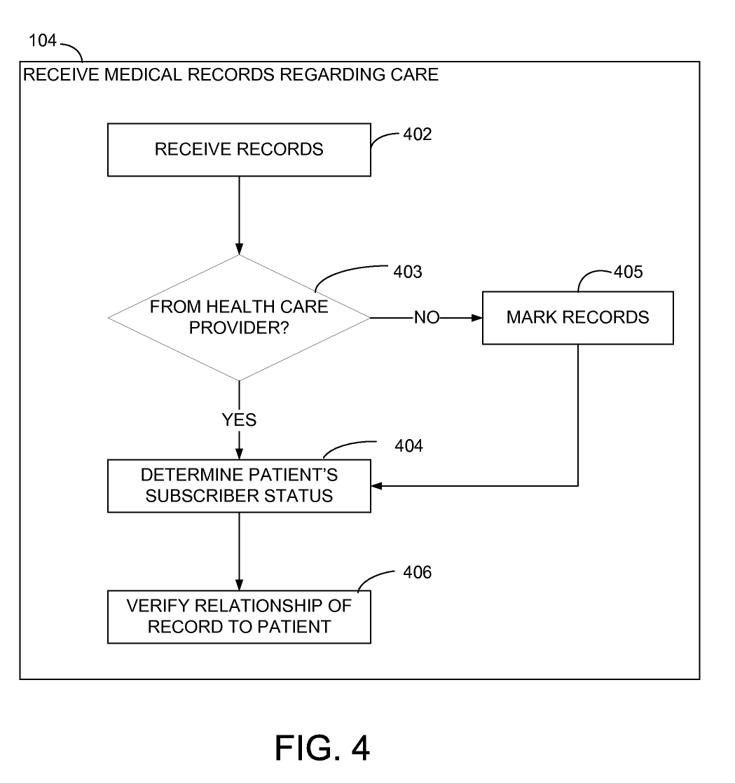

In step 104, the business receives medical records from a licensed health care provider or licensed health care facility. In some alternate embodiments, the receipt of the records in step 104 will also be the notification of step 102. For example, where the business has contracted with such a licensed health care provider or licensed health care facility, such as a hospital, to provide medical record services, the first indication that records have been produced may be the receipt of the records by the business. The records are preferably received by fax or by certified mail. Records may also be received by hand delivery from an employee of the health care provider or facility, from a bonded courier, or by secure transmission. In all cases, all elements in the chain of custody of the records record must be legally reliable. More details regarding step 104 will be provided below in regard to FIG. 4.

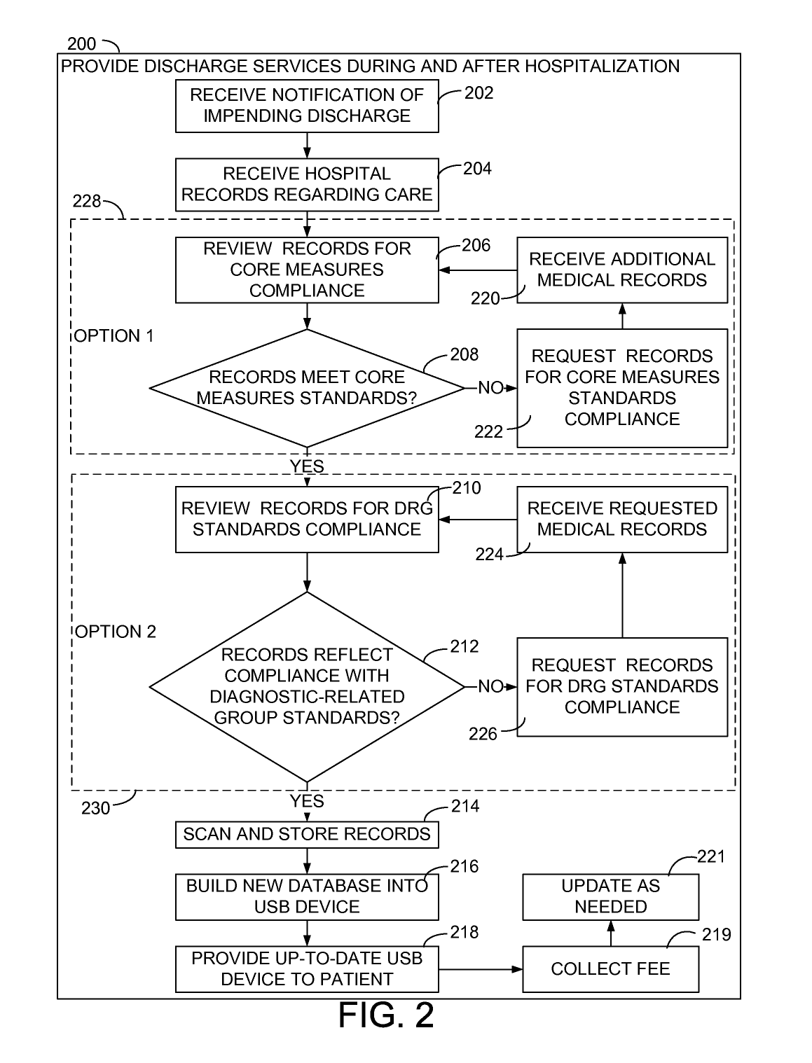

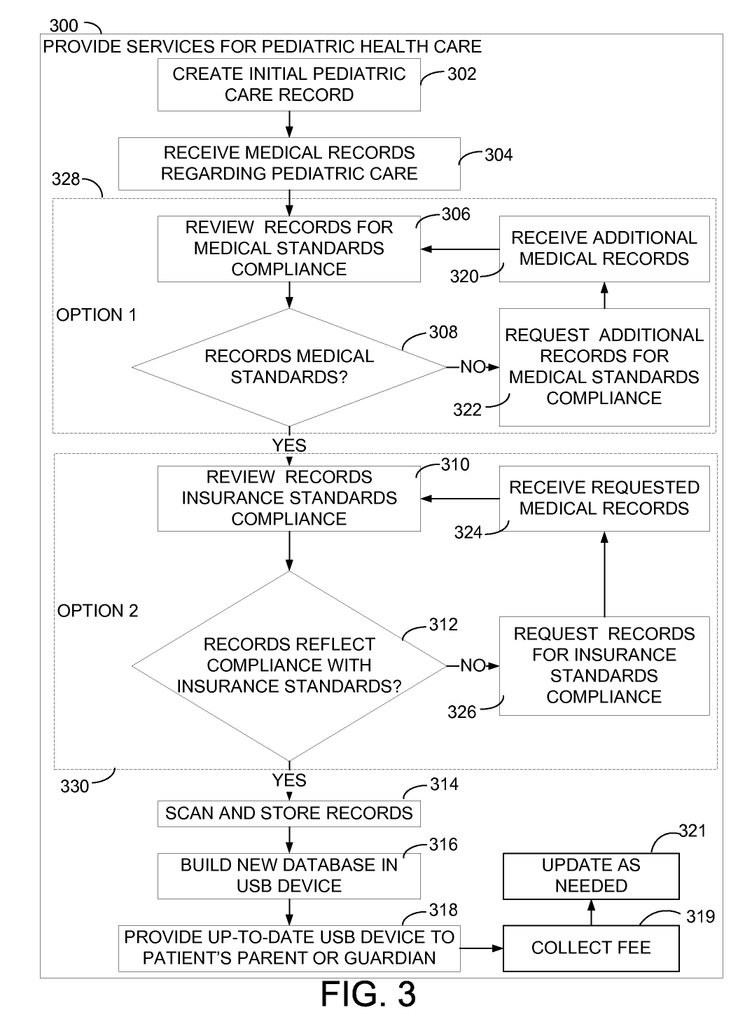

Once the records are received in step 104, there are two optional services that the novel business may provide on contract to the health care provider or facility. Option 128 includes a review 106 of the medical records for compliance with medical standards. Review 106 may be accomplished in part automatically using a computer or may be assisted through the use of a computer. The health care provider specifies the medical standard to be used and the business applies that specific standard to the records received in step 104. In decision step 108, the business makes a determination as to whether or not the received medical records meet the specified medical standard. The business accomplishes this decision 108, as with other decision steps 112, 208, 212, (FIG. 2) 308, and 312 (FIG. 3) through employees or agents who are certified health care professionals and who may be using or may be assisted by software provided by the standards organization or by the business. If the records do not meet the specified medical standards, additional records are requested in step 122. The records requested in step 122 are only those required to bring the medical records into compliance with the specified standards. Note that no implication is made in step 122 that the records not meeting the specified medical standards reflect a failure to provide appropriate care, but only that the records need to meet the specified medical standards. This distinction is legally significant and a novel aspect of the invention.

In step 120, the business receives additional medical records in the manner described in step 104. The additional medical records are combined with the previously received medical records and the review is re-accomplished in step 106. Not shown in FIG. 1 is that a limit may be placed on the number of reviews 106 for medical records that concern the same medical events. For example, if a third or subsequent request 122 for additional records is made, an additional cost may be billed by the business to the health care provider. By making records deficiencies costly, the contract focuses the health care provider's managerial and supervisory attention on the problem.

If the decision step 108 determines that the medical records reviewed in step 106 are in compliance with the specified medical standards, then optional service 130 may be provided. Optional service 130 includes a review 110 of the received medical records for compliance with insurance standards. Records that are not in compliance with insurance standards can significantly delay payment to the health care provider. The insurance standard to be used in step 110 is specified by the health care provider. In decision step 112, the business determines whether the medical records received in step 104 are in compliance with the specified insurance standards. If not, the business requests 126 additional records needed to bring the whole set of records into compliance with the specified insurance standards.

In step 124, the additional requested medical records are received by the business in the same manner as records were received in step 104. The additional medical records are combined with the medical records previously reviewed 110 and are again reviewed in step 110. This process may be iterated, just as with optional service 128, but a limit on iterations is effectively established by charging the health care provider (record provider) for excessive reviews 110. If the business determines, in decision step 112, that the received medical records are in compliance with the specified insurance standards, then system 100 continues at step 114. Note that, in some instantiations, neither option 128 nor option 130 will be selected by the health care provider, and the process will proceed directly from step 104 to step 114.

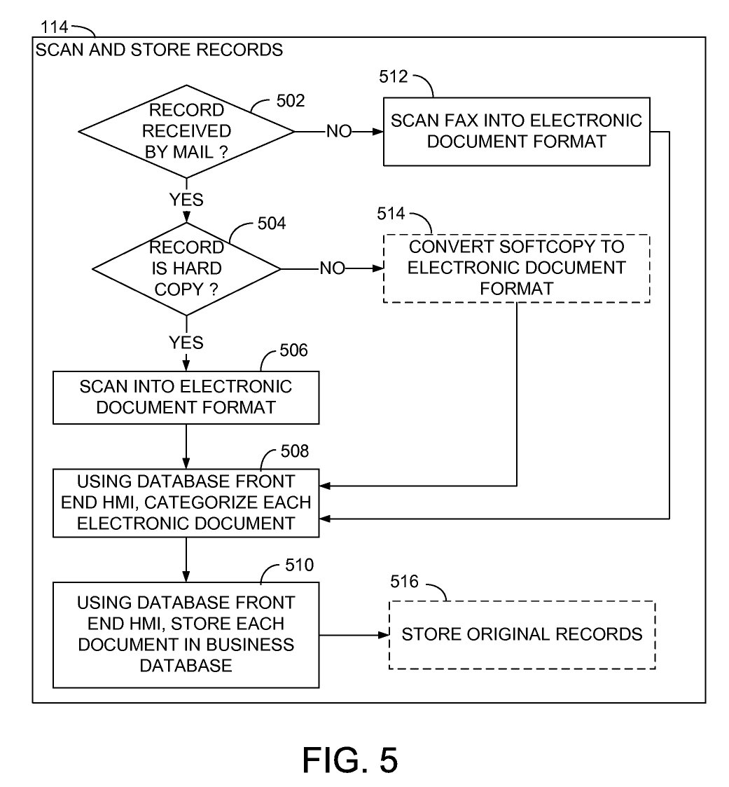

In step 114, the business scans and stores the received medical records into a business database on a secure server. The details of this process are discussed in greater detail below in regard to FIG. 5. In a particular preferred embodiment, the records may be transferred electronically between two computers, such as a hospital computer and a business computer, making scanning unnecessary. The transfer between computers may be automated in some situations, such as when both computers are located in a hospital coupled to a secure local network. At the end of step 114, the records are organized and stored in a business database in a format compatible with display and database software.

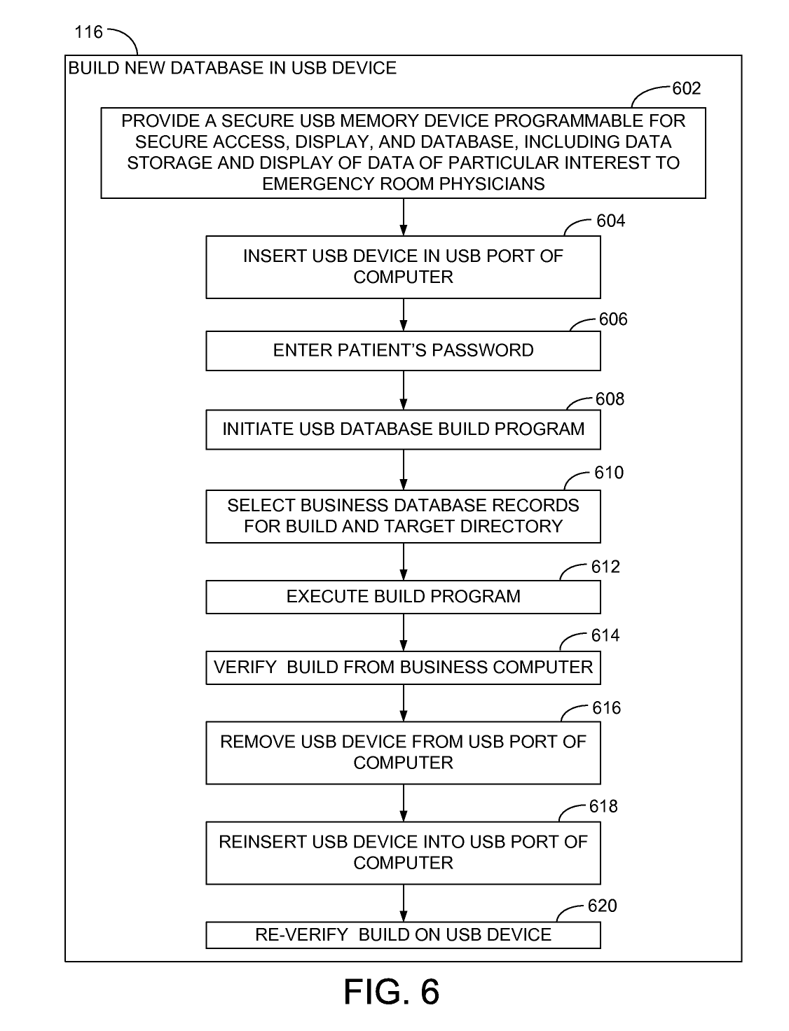

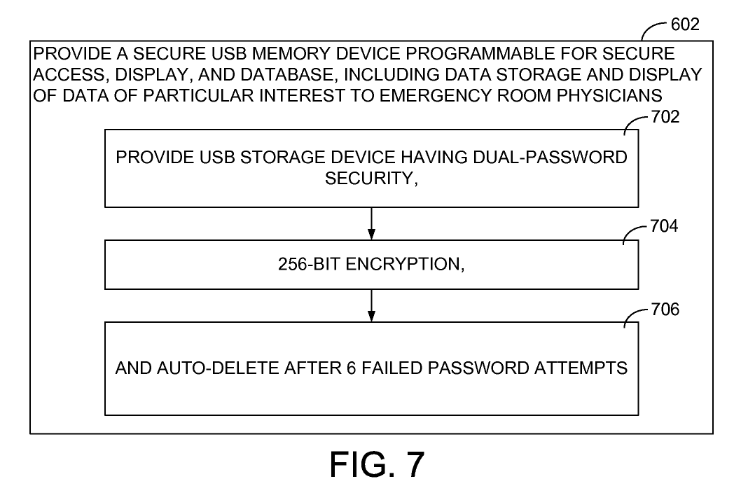

In step 116, the business creates an auto-running database on portable medical record media, for example, a secure USB device. Step 116 places a portable, self-running database of the patient's received medical records on the secure USB device that can be accessed only for viewing through the password protection of the secure USB device. This process will be discussed in more detail below in regard to FIG. 6 and FIG. 7. It is a novel feature of the invention that the contents of the USB database may only be changed by the business, which only accepts records from care providers, most preferably limited to documents dictated by physicians.

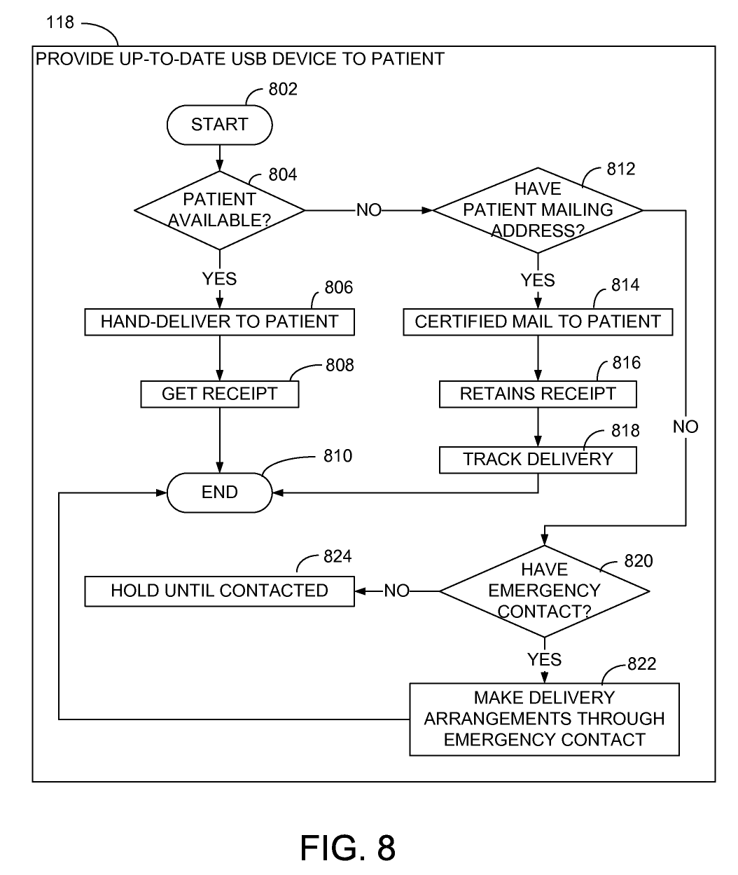

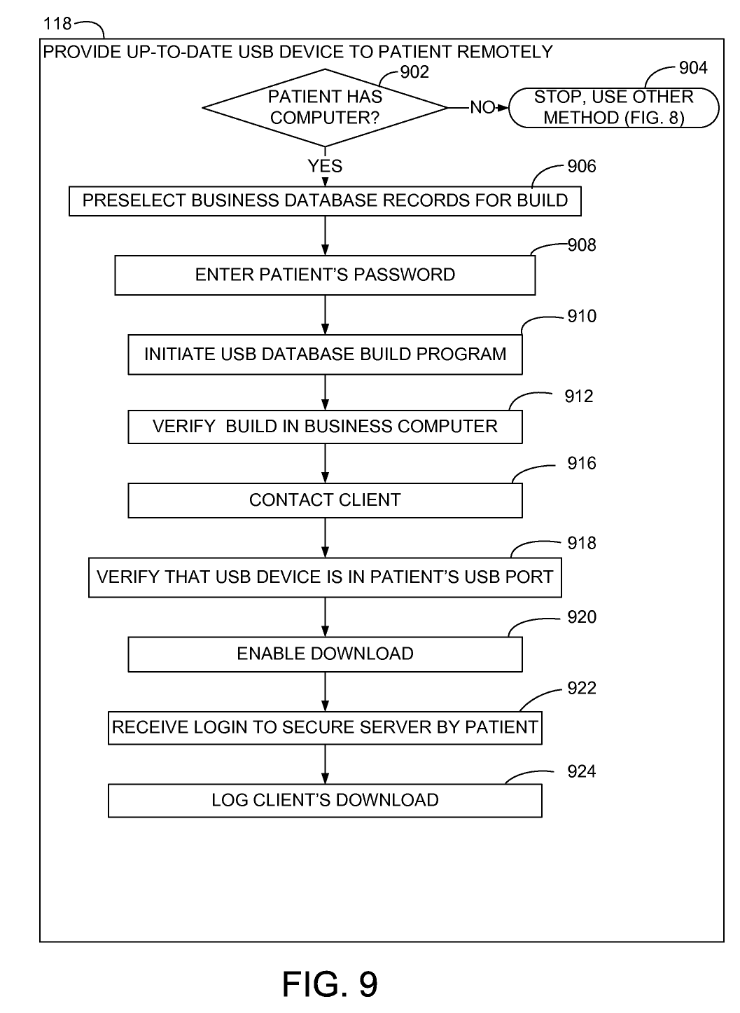

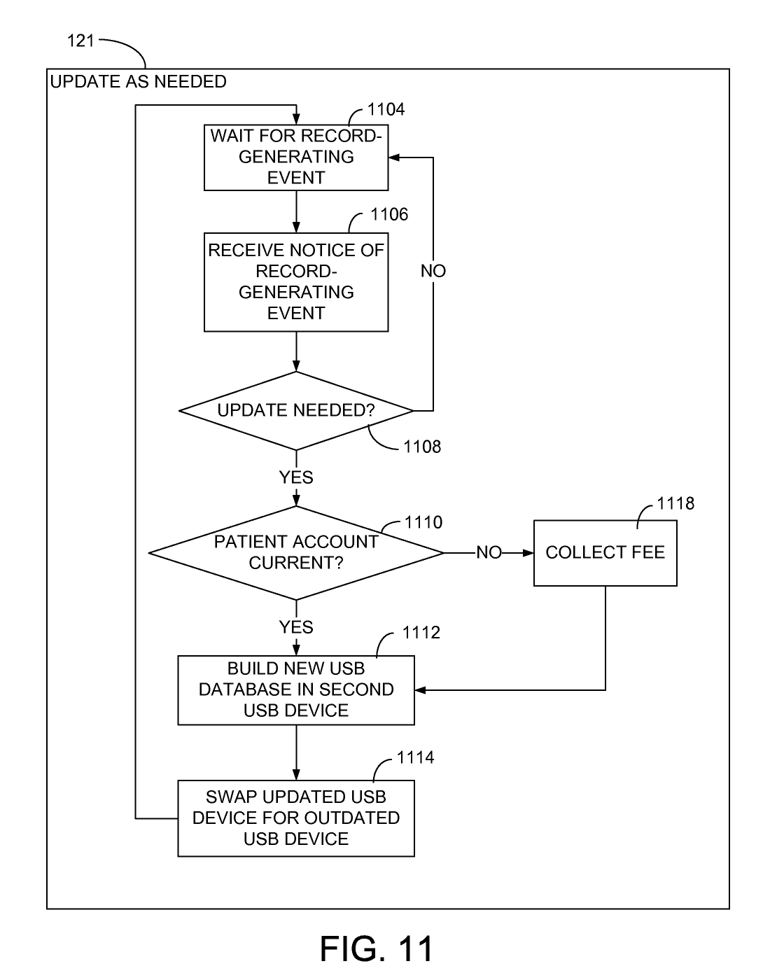

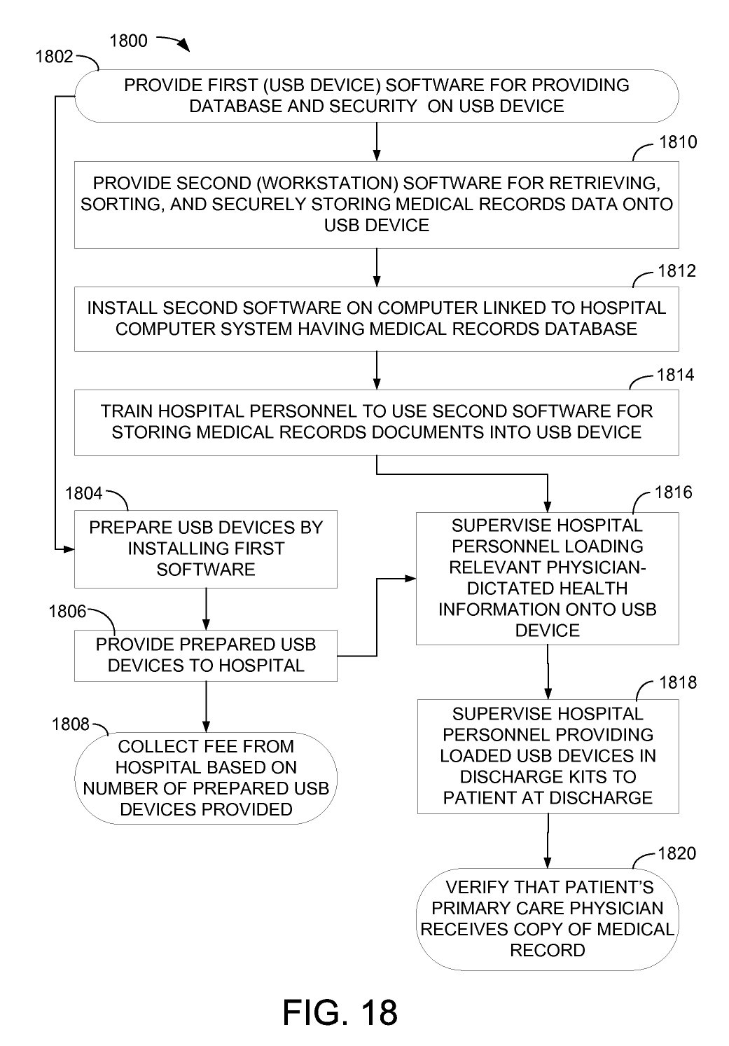

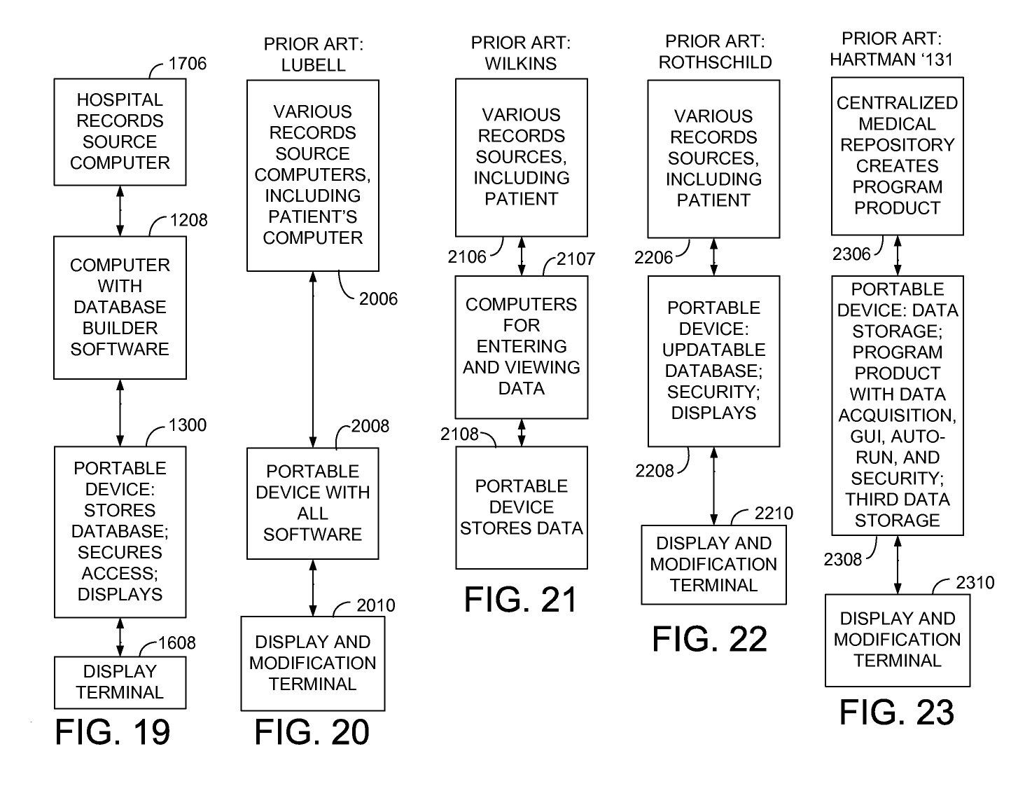

In step 118, the business provides the up-to-date secure USB device, with the personal medical records database, to the patient. This process will be discussed in more detail below in regard to FIG. 8 and FIG. 9. In step 119, the business collects the fee for the service and for the USB device. In various other embodiments, the fee may be collected 119 at the beginning of system 100, or at any intermediate point. In a particular preferred embodiment, a fee may be charged to an institution, such as a hospital, based on the number of USB devices provided to patients of that institution or to the institution itself. In step 121, the USB device may be updated. Step 121 options will be discussed in more detail below in regard to FIGS. 11 and 19.

FIG. 2 is a process chart illustrating a business process for providing an improved personal medical records system 200, according to another exemplary embodiment of the present invention. System 200 is a variation of system 100 adapted for providing discharge services as a subcontractor to a hospital. In an alternative embodiment, system 200 may be practiced by a hospital, or other health care provider facility, as part of the hospital's normal business. Step 202 includes communication from the hospital that a patient is scheduled to be discharged, and is otherwise similar to step 102. Step 204 may include receiving hospital records at a location within the hospital where the business has office space as provided in the subcontract, and is otherwise similar to step 104.

Option 228 is similar to option 128, but includes review for Core Measures compliance. Core Measures are formal medical standards developed by The Joint Commission for measuring the performance of hospitals. In system 200, Core Measures are the medical standards specified by the health care provider. In decision step 208, the business compares the Core Measures with the received medical records and determines whether or not the received medical records reflect compliance with the relevant Core Measures. If the business determines, in step 208, that the records do not reflect compliance with Core Measures, then the business will request additional medical records in step 222, which is similar to step 122. When the business receives additional medical records in step 220, the business will combine the additional medical records with the medical records already received and review all the medical records in step 206, and make a new decision in step 208.

Option 230 is similar to option 130, but includes review 210 for Diagnostic-Related Group (DRG) standards, which were developed by Centers for Medicare and Medicaid Services (CMS) for supporting Medicare and Medicaid payments to hospitals. Thus, the DRG standard is a type of insurance standard specified by the hospital. There are various sets of DRGs presently in use, and the particular DRG is specified by the hospital. In various embodiments, the DRGs used may vary as a function of patient-related variables or facility-related variables. In step 212, the business determines whether or not the received medical records are in compliance with the DRG standards. If the received medical records are not in compliance with the DRG standards, then the business requests 226 additional medical records from the hospital. When the additional medical records are received 224, they are added to the medical records already received and reviewed 210 for DRG compliance. The number of iterations of option 230 may be controlled by charging additional fees for excessive iterations. When the medical records have passed reviews 208 and 212, the records are scanned and stored in step 214, which is the same as step 114, which is discussed below in more detail regarding FIG. 5.

In step 216, the business preferably builds the new database in a secure USB device at a location inside the hospital, to maximize the convenience of the patient. The new build may overwrite the patient's existing USB device, but preferably writes the new medical records, along with the preexisting records in a new database either on a new secure USB device which is exchanged for the patient's pre-existing USB device, or on the patient's original device. This process ensures that the latest USB security software is also available for the patient's records.

In step 218, the new USB device with the new medical records database is provided to the patient. Step 218 is similar to step 118, but usually involves direct contact with the patient. If the patient is not a personal medical records service subscriber with the business, the service is offered to the patient when the USB device is provided 218. Step 218 is discussed in greater detail below in regard to FIG. 8 and FIG. 9.

Step 219 is optionally different from step 119, in that the fee is preferably collected 219 through the hospital, and most preferably on a per-USB-device basis, who passes the cost on to the patient in the course of normal hospital billing. The business will update 221 the USB device, by methods discussed in more detail below in regard to FIG. 11 and FIG. 19.

FIG. 3 is a process chart illustrating a business process for providing an improved personal medical records system 300, according to yet another exemplary embodiment of the present invention. System 300 is an adaptation of system 100 used for pediatric care records. Pediatric records may include a well child plan, which includes dates for checkups, vaccinations, and the like. The pediatric record may be initially created 302 by a doctor at a pediatric clinic. The records are received by the business in step 304, which is similar to step 104, and is more fully discussed above in regard to FIG. 1 and also below in regard to FIG. 4.

Options 328 and 330 are the same as options 128 and 130, except that the standards applied are those relevant to pediatric care. In step 306, the business reviews the received medical records for compliance with medical standards for pediatric care. The specified standards may be Core Measures or other standards used by a medical practitioner or developed by an accrediting organization. In decision step 308, the business determines whether or not the received medical records reflect compliance with the specified medical standards. If the business determines, in step 308, that the received medical records are not compliant with the standards, then the business requests 322 additional medical records. The business receives the additional medical records in step 320 in the same way as in step 104 or 204, and combines the additional medical records with the medical records already received. The combined medical records are then reviewed 306 again and a new decision 308 is reached.

In step 310, the business reviews the received medical records for compliance with insurance standards for pediatric care. The specified standards may be DRGs or other standards used by an insurance company or government entity. In decision step 312, the business determines whether or not the received medical records reflect compliance with the specified insurance standards. If the business determines, in step 312, that the received medical records are not compliant with the specified standards, then the business requests 326 additional medical records. The business receives the additional medical records in step 324 in the same way as in step 104 or 204, and combines the additional records with the records already received. The combined medical records are then reviewed 310 again and a new decision 312 is reached.

The received and, optionally, reviewed records are scanned and stored in step 314 in the same way as step 114, which is discussed in further detail below in regard to FIG. 5. In step 316, the business builds a new pediatric database in a USB device. The new USB device, with its up-to-date pediatric database, is provided to the parent or guardian in step 318. The pediatric database may be sold as a one-time sale without subscription, and updates may be made on a pay-as-you-go-basis. The fee is collected, in step 319, from the parent or guardian. Updates 321 may be made when needed, for a separate additional fee by methods of FIG. 11 or FIG. 19.

FIG. 4 is a process chart illustrating a detail of the business process for providing an improved personal medical records system 100 of FIG. 1, according to exemplary embodiments of the present invention. Step 114 includes the steps 402, 403, 405, 404, and 406. In step 402, records are received from either a health care provider that generated the records, from a subsequent holder with a verifiable chain of custody to the provider, or from the patient. If 403 the records are received from the patient, the patient-supplied records are marked 405 as such in the computer files and databases. Such patient-provided records may optionally form the basis for a request from the business to the alleged health care provider that allegedly generated the patient-provided records. The patient's subscriber status is checked in step 404 to determine if a new USB database is still appropriate, or if and update for an existing subscriber to the business' portable medical records service is needed. In step 406, each page of the received medical records is checked for association with the patient on whose behalf the records were received. This step 406 is also used, but not shown, after storing 114 the received medical records and after building 116 the new USB database 1308 (see FIG. 13).

FIG. 5 is a process chart illustrating another detail of the business process for providing an improved personal medical records system 100 of FIG. 1, according to exemplary embodiments of the present invention. Step 114 includes decision step 502 in which medical records received by certified mail or courier are differentiated from records received by fax. Records received over a secure local network go directly and, preferably, automatically to storage in step 516. Mailed records may include electronic media and faxes do not. If the business determines, in step 502, that the medical records are faxed, the faxed medical records are scanned 512 to make electronic copies in a preferred electronic document format, such as Portable Document Format (.pdf). If the medical record was mailed, decision step 504 is used to differentiate hard copy (paper documents, films, and the like) from softcopy (electronic data stored on media). If the business determines, in step 504, that the records are softcopy, those records may, optionally, be converted into a preferred electronic document format in step 514. Medical images create a special problem because the size of the data files may overwhelm the memory capacity of the USB portable medical records database 1308. Advances in image compression enable compressed images, adequate for emergency medicine, if not detailed analysis, to be stored in the USB portable medical records database 1308, often as PDF files.

If the received medical records are hardcopy records, as determined in step 504, then the received medical records are scanned 506 into a preferred electronic document format. Once the received medical records are scanned 506 into a preferred electronic document format, they become electronic documents, and each document is associated with one or more database categories 508, using a database front-end HMI. The HMI preferably enables the medical professional, including medical staff members, to drag and drop or copy and paste the documents into the appropriate categories. A guidebook, or “software bible” lists the categories and which type of electronic documents go in each category. In addition, each document category may contain information about other categories with which the particular document should also be associated. Once each document has been associated with all appropriate categories, the documents are stored 510 in the business database on the business secure server, preferably with a single icon click on the HMI graphical user interface. The original received medical records may optionally be stored 516 by the business, depending on patient preference and willingness to pay for the storage. Otherwise, the hardcopies are destroyed.

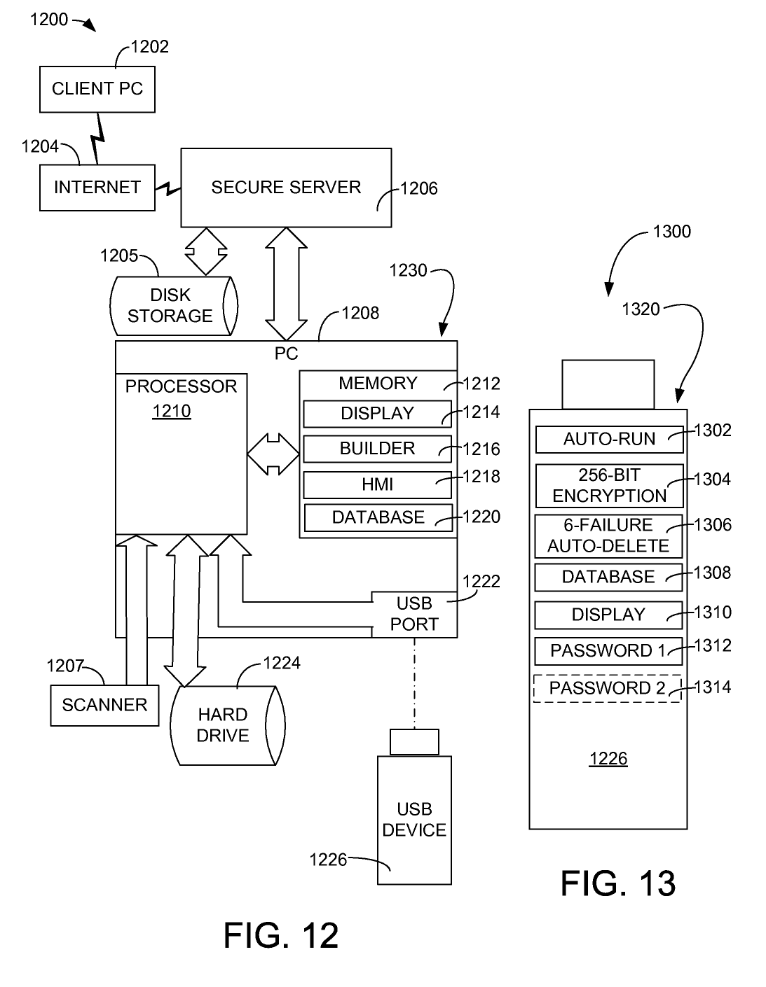

FIG. 6 is a process chart illustrating yet another detail of the business process for providing an improved personal medical records system 100 of FIG. 1, according to exemplary embodiments of the present invention. Step 116 begins with providing 602 a secure USB memory device 1300 that is programmed for security, for displaying data, and that has a database or has room for a database 1308 that includes storage and display of data of particular interest to emergency room physicians. The data display program may be part of the database program, in some embodiments. At the end of step 602, the business has a USB device 1300 (see FIG. 12-13) ready to receive a new portable medical records database 1308. Step 602 will be discussed in more detail below in regard to FIG. 7.

The prepared USB device 1300 is inserted 604 in the USB port 1222 of a computer 1208 owned and secured by the business and which has access to the business database. While the exemplary embodiments are presented as using USB devices 1226, any other portable plug-and-play device capable of storing database 1308 and auto-run programs 1302 may be used. The password 1312, 1314 security screen will have auto-run when the USB device 1300 is inserted. The medical staff member operating the computer enters 606 the patient's password to gain access to the business database files 1220. In step 608, a medical staff member operates the computer 1208 that is coupled to the USB device 1300 to initiate 608 the building of the USB portable medical records database 1308. Preferably, this includes gaining access to the files, or documents, in the business database that will be placed in the USB portable medical records database 1308. In step 610, the operator selects the business database records that will be used to build the USB portable medical records database 1308. The selected records may include the new records along with all or some previous records, as determined appropriate by the medical staff member generating the USB portable medical records database 1308. In step 612, the medical staff member executes the build program, targeting the USB device 1226 as the destination drive for the build. At the end of step 612, there is a secure, accessible USB portable medical records auto-run database 1308 installed on the USB device 1226. Using a feature of the build program, the medical staff member views the newly built USB portable medical records database 1308 and verifies 614 that each record is correct. The medical staff member then removes 616 the prepared USB device 1300 from the USB port 1222 and reinserts 618 the USB device 1300 into the USB port 1222 of the computer 1208. The medical staff member then re-verifies 620 each record in the USB portable medical records database 1308 as it auto-runs after password 1312, 1314 security has been satisfied. At the end of step 620, the business is in possession of a fully programmed, secure, prepared USB device 1300 having a patient's USB portable medical records database 1308 that is auto-run 1302 responsive to the entry of the patient's password 1312, 1314.

FIG. 7 is a process chart illustrating a detail of the procedure 602 in FIG. 6 of the business process for providing an improved personal medical records system 100 of FIG. 1, according to an exemplary embodiment of the present invention. Step 602 begins with providing 702 a prepared USB device 1300 having dual-password 1312, 1214 security. Dual-password 1312, 1314 security may be programmed by the business or may be programmed into the USB device 1226 by the vendor of USB devices. One password 1312 is the patient's password. The second password 1314 may be the business password and provides a separate access path to the USB portable medical records database 1308 in an emergency event where the patient is unable to assist with providing access. Prior written consent of the client is required for a business password 1314. At the option of the patient, or client, there may be no second password 1314. The data contents of the prepared USB device 1300 are encrypted 704, preferably with 256-bit encryption. Various encryption methods that provide adequate protection required by HIPAA, or that exceed HIPAA requirements, may be alternatively used. As a further defense against tampering, an auto-delete 706 capability is programmed into the prepared USB device 1300. The auto-delete function 706 will automatically delete all data contents after six failed password attempts. At the end of step 706, the business has a secure programmable memory device, preferable prepared USB device 1300.

FIG. 8 is a process chart illustrating still yet another detail 118 of the business process for providing an improved personal medical records system 100 of FIG. 1, according to exemplary embodiments of the present invention. Step 118 may start 802 when the prepared USB device 1300 is ready for delivery to the patient. If 804 the patient is physically present, the prepared USB device 1300 is hand-delivered 806 to the patient by a medical or business staff member, who obtains 808 a receipt from the patient. If 804 the patient is not physically present, then if 812 the business has the patient's mailing address, a medical or business staff member mails 814 the prepared USB device to the patient by certified mail, retains 816 the certified mail receipt and tracks 818 delivery through the USPS online tracking feature. Documentation of delivery is retained by the business. If 812 the business does not have a valid mailing address for the patient (usually discovered by the mail 814 not being delivered), then if 820 the patient has an emergency contact in the business database, the business will make delivery arrangements 822 though the emergency contact. If all contact is lost, the business will hold 824 the prepared USB device 1300 until contacted. The essence of step 118 is that the prepared USB device 1300 is only transferred to the patient by a medical or business staff member using means that are traceable. Each delivery thread ends 810 when the USB device 1300 with the USB portable medical records database 1308 is delivered and delivery is documented.

FIG. 9 is a process chart illustrating still yet another detail 118 of the business process for providing an improved 100 of FIG. 1, as an alternative to the method shown in FIG. 8, according to exemplary embodiments of the present invention. An alternate approach to step 118 is available. If 902 the patient has a computer 1202 that is connectable to the internet 1204 then the alternate step 118 may be used. If 902, the patient does not have a computer 1202 connected to the internet 1204, or if the patient does not wish to use the computer method, then the other method described in regards to FIG. 8, above, must be used 904. The essence of the alternate method of step 118 is to build the USB portable medical records database 1308 in the business computer and then enable the patient to download the built USB portable medical records database 1308 to the patient's prepared USB device 1300 coupled to the patient's computer. The step 118 uses the secure server 1206 of the business and a secure internet connection. In preparation, the business database records for the build are pre-selected 906 by a medical staff member and are isolated in an account accessible only by the business. The medical staff member enters 908 the patient's password and initiates 910 the USB portable medical records database 1308 build program. Once the database build is complete, the medical staff member verifies 912 the build in the business computer 1208. The business then contacts 916 the client to arrange for a download. The business receives a secure login to the business' secure server 1206 by the patient. The access to the secure server 1206 provided to clients is limited to the client's own USB portable medical records database 1308. The business then verifies 918 that the patient's prepared USB device 1300 is available, such as by being inserted in a USB port in the client's computer 1202. Step 918 may be accomplished by software or by telephonic contact. The business then enables 920 the download, preferably for a limited period of time. The business next receives 922 the secure logon of the patient and then logs the download of the client's USB portable medical records database 1308. At the end of step 924, a new build of the patient's USB portable medical records database 1308 is present on the patient's secure prepared USB device 1300.

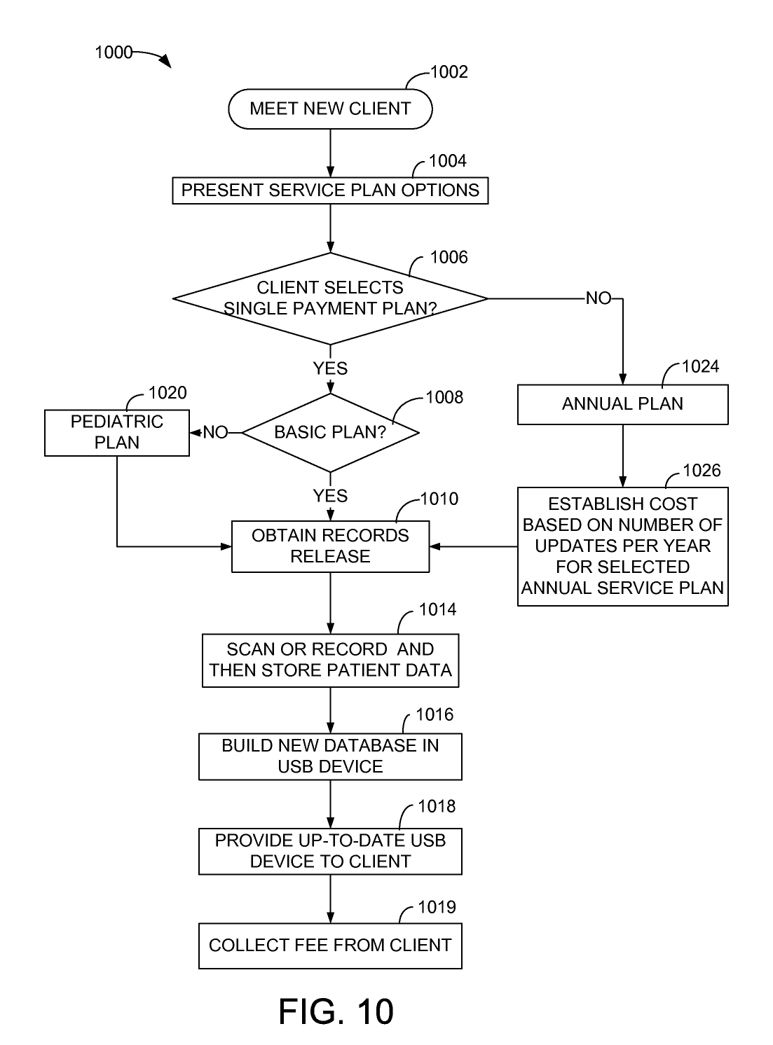

FIG. 10 is a process chart illustrating a client intake process for providing an improved personal medical records system 1000, according to an alternate exemplary embodiment of the present invention. In system 1000, a medical staff member at the business meets 1002 the new client. This may occur at the principal place of business, at an office in a hospital, or at a sales kiosk at any of various locations. The medical professional or medical staff member presents 1004 service plan options to the new client. Preferably, the service plans provide single payment options for basic service and for pediatric service, and at least three annual subscription options providing fixed numbers of pre-paid updates as part of the service plan. If the client selects 1006 a single payment plan and if 1008 it is the basic plan, then the business will obtain 1010 one or more records releases from the client and receive copies of the client's records, as needed. If 1008 the client does not select a basic plan, but has selected 1006 a single-payment plan, then the plan is a pediatric plan 1020. The business will obtain 1010 one or more records releases from the client and receive copies of the client's pediatric records. Single-payment plans may be updated on a pay-as-you-go basis.

If the client does not select 1006 a single-payment plan, then the plan is an annual subscription plan 1024. The cost of the annual subscription plan is established based on the number of prepaid updates per year. The business will obtain 1010 one or more records releases from the client and receive copies of the client's medical records. The business may also provide the client with a number of medical release forms equal to the number of prepaid updates in the client's subscription plan, so that the client can give the forms to health care providers as new medical record-generating events occur. In step 1014, the business scans or records the patient's medical records and stores them in a business database the same way as is described regarding step 114 in FIG. 1 above. The business then builds 1016 a new USB portable medical records database 1308 in a prepared USB device 1300 in the same manner as described regarding step 116 in FIG. 1. The business then provides 1018 the up-to-date prepared USB device 1300 to the client and collects 1019 a fee from the client if the number of updates exceeds the number of updates in the patient's original plan.

FIG. 11 is a process chart illustrating another detail of the business process for providing an improved personal medical records system 100 of FIG. 1, according to an exemplary embodiment of the present invention. Step 121 begins with waiting 1104 for a medical record-generating event. In step 1106, similar to step 102 described above in regard to FIG. 1, the business receives notice of a medical record-generating event. In decision step 1108 the business decides, on the basis of client input and possibly health care provider input, whether an update is needed. If 1108 no update is needed, then the business waits 1104 for the next medical record generating event to again implement decision step 1108. If 1108 the business decides that an update is needed then the business must decide 1110 if the patient account is current. If 1110 the patient's account is current, then the business builds 1112 a new USB portable medical records database 1308 in a second prepared USB device 1300 and the swaps 1114 the new prepared USB device 1300 for the outdated one. The business then waits 1104 for the next medical record-generating event. If 1110 the patient account is not current, then it is brought current by collecting 1118 a fee from the client, after which, the business builds 1112 a new USB portable medical records database 1308, and so forth as previously described.

FIG. 12 is a block diagram of a computer apparatus 1200 for implementing the business process for providing an improved personal medical records system 100 of FIG. 1, according to an exemplary embodiment of the present invention. A personal computer 1208 is a workstation for the execution of the business system 100. Preferably, there are a plurality of workstations 1208 connected to each secure server 1206. The secure server 1206 has disk, or other long-term, storage 1205, for storing the business database 1220. The secure server 1206 may have a secure link to the internet 1204 providing a secure link to a client's personal computer 1202 to assist in execution of alternate step 118 as described above in regard to FIG. 9.

Personal computer 1208 preferably has a processor 1210 communicatively linked to memory 1212, a USB port 1222, a scanner 1207, and a hard drive 1224. The memory 1212 holds a database program 1220, an HMI 1218 with a graphical user interface, a database builder 1216 for building the USB portable medical records database 1308, and associated display software 1214, cumulatively referred to as second software 1230. Second software 1230 may be a collection of separate software programs or, in a particular embodiment, may be integrated into one software package. Database program 1220 may be used to access the business database on the disk storage 1205 through secure server 1206, or for organizing and storing files created by the scanner 1207 onto the hard drive 1224. The USB port 1222 is operable to physically and communicatively receive USB device 1226.

Database program 1220 and HMI 1218 are operable to be used to organize and store 114 records which have been scanned or stored 114 into memory 1212, preferably into database 1220. The records are preferably also stored in the business database on the disk drive 1205. The HMI 1218 preferably enables the medical professional or medical staff member using the HMI 1218 to examine the records, or documents therein, in order to determine the appropriate database categories for each. The HMI 1218 and database 1220 preferably cooperate to enable the medical professional or medical staff member to drag and drop documents into database categories. Emergency room medicine has its own category, and the records associated with the emergency room category (ED) are organized to provide rapid access to the records that are most important to emergency room physicians. The emergency room medicine category, its access, organization and operation combine to form a novel feature of the present invention.

Database builder 1216 is operable to build a USB portable medical records database 1308 that is secure, that runs automatically, and that is accessible only for viewing, once the patient's password has been entered. The builder 1216 is operable to build a database 1308 having a tab for emergency room medicine, so that display of records relevant to emergency room care may be rapidly accessed by persons with only minimal competency in the operation of personal computers.

FIG. 13 is a block diagram of a portable health record media 1226 for implementing the business process for providing an improved personal medical records system 100 of FIG. 1, according to an exemplary embodiment of the present invention. The portable health record media 1226 is preferably developed into a prepared USB device 1300 and is preferably worn as jewelry, such as a necklace or bracelet. In an alternate embodiment, the prepared USB device 1300 may be kept on a key ring. In yet another alternate embodiment, the USB device 1300 is kept in a wallet. For most embodiments, the business will provide a bright red emergency information wallet card, sized like a driver's license, which will have the patient's identification, emergency contacts, and emergency contacts' phone numbers. The patient will be advised to keep the emergency card just behind the patient's ID card or driver's license, as emergency room personnel are trained to find the wallet and the driver's license for identification purposes, and will thereby find the bright red emergency card. The bright red emergency card will also provide basic instructions on how to use the prepared USB device 1300.

The USB device 1226 must have first software 1320 installed to be used with the improved personal medical records system 100. First software 1320 includes auto-run software 1302, 256-bit encryption software 1304, six-failure auto-delete software 1306, a database 1308, display software 1310, and first and second passwords 1312 and 1314. The USB device 1300 has multiple levels of security to maintain the privacy of the patient and his or her medical records. The first layer of security is that the records are encrypted, preferably with at least 256 bit encryption 1304. Various encryption approaches may be used in various embodiments. The second layer of security is dual-password security. A first password 1312 is the patient's password which enables the USB portable medical records database 1308 to auto-run, using either separate auto-run 1302 software or auto-run 1302 software intrinsic to the USB portable medical records database 1308 program. The patient's password 1312 may be kept confidential by the patient, or may be given, by the patient and not by the business, to trusted emergency contacts. While the requirement for the business to keep the patient's medical records confidential is based in law, the patient has no such restriction, and so the patient can reveal the patient's medical records to anyone the patient chooses. In a case of extremely poor health, a person wearing the USB device containing the USB portable medical records database 1308 may also wear a separate tag on the same necklace giving the patient's password, so that emergency room personnel would have immediate access to the records, even if the patient could not assist. However, the business cannot provide such tags, as that would put the business in the position of subverting the security system for the medical records, which the business may not lawfully do.

The second password 1314 may be the business' password, and allows the business to assist the emergency room physician in gaining access to the USB portable medical records database 1308. The access provided by the second password 1314 is the same as the access provided by the first password 1312. The second password 1314 may be sent out by the business to the patient or to one of the patient's emergency contacts if the requester answers two security questions and provides an email address where the password may be sent. A signed consent form from the patient is required for emergency distribution of the password 1314.

The auto-delete 1306 program monitors the entry of passwords and deletes all data on the prepared USB device 1300 after a predetermined number of failed password attempts, preferably six. The combination of dual-password 1312, 1314 security, 256-bit encryption 1304, an auto-delete 1306 function, and a USB portable medical records database 1308 is a novel feature of the invention.

The display software 1310 may be independent or may be intrinsic to the USB portable medical records database 1308. The first screen after the password screen shows the identification page, preferably including a photograph of the patient. The second screen shows multiple selectable tabs, one for each database category. The tab for medical records relevant to emergency services is preferably bright red, and the screen contains instructions to the emergency room personnel to click on the tab for the desired records. Frequently, emergency medicine is practiced in a hurry, with no medical records to refer to, and only interview results to provide any clues regarding prior medical conditions. Where time is of the essence, it is essential that the medical records needed in emergency medicine be immediately accessible. The organization of the data is critical and the speed with which emergency room personnel can learn to use the USB portable medical records database 1308 is critical. The combination of clear on-screen instructions, point-and-click access, and accessibility to the red tab of the emergency medical records screen with one click from any other screen is a novel feature of the present invention.

Each database category is associated with a list of documents that make up medical records that are to be associated with that category in the USB portable medical records database 1308. Each category may be associated with related categories. The categories are selected and organized only by medical professionals and the task of organizing medical records in the database is performed only by medical professionals and medical staff members under the supervision of medical professionals. The medical records are received primarily from health care providers. Medical records received from patients are marked in the database and in the database display so that a physician using the records can tell which are traceable to health care providers and which are traceable through patients. A novel feature of this invention is that what the physician viewing the USB portable medical records database 1308 sees is reliably traceable to other physicians who authored the documents in the record. Only the business can build a USB portable medical records database 1308, and no patient or viewing physician can modify the USB portable medical records database 1308. Accordingly, the viewing physician may legally rely on the records, even though they have been in the possession of the patient. This is a novel feature of the present invention.

The USB device 1226 with first software 1320 installed is referred to as prepared USB device 1300.

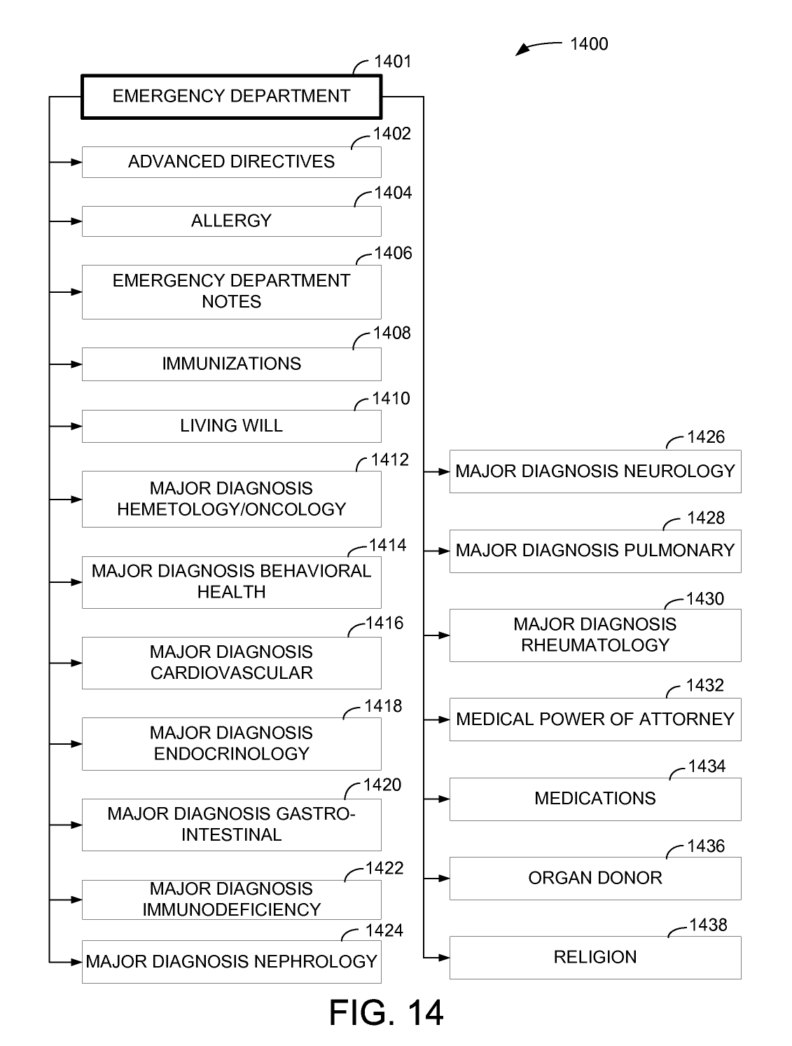

FIG. 14 is a block diagram illustrating a novel pattern 1400 of organization for emergency medicine data used in the business process for providing an improved personal medical records system 100 of FIG. 1, according to an exemplary embodiment of the present invention. Under the category 1401 of the emergency department screen, the medical professional or medical staff member will find point and click tabs for each of the subcategories 1402, 1404, 1406, 1408, 1410, 1412, 1414, 1416, 1418, 1420, 1422, 1424, 1426, 1428, 1430, 1432, 1434, 1436, and 1438 illustrated. Pointing and clicking on any tab will bring up a more detailed screen presenting documents in that subcategory 1402-1438. The novel pattern of organization is designed to provide emergency room medical staff and professionals the data critical to the practice of emergency medicine. Subcategory 1402 is for advanced directives, as shown. Subcategory 1404 is for allergy data, including allergies to medications, vaccines, anesthesia, and other substances, plants, animals, or venoms. Subcategory 1406 includes emergency department notes made during previous visits to the emergency room. Subcategory 1408 provides the status of immunizations, especially important for international travelers. Subcategory 1410 provides the patient's living will, with appropriate signatures and notarization. Subcategory 1412 provides documents relating to any major diagnosis in the fields of hematology and oncology. Subcategory 1414 provides documents relating to any major diagnosis in the field of behavioral health, such as mental disorders. Subcategory 1416 provides documents relating to any major diagnosis in the cardiovascular field. Subcategory 1418 provides documents relating to any major diagnosis in the field of endocrinology. Subcategory 1420 provides documents relating to any major diagnosis in the field of gastroenterology. Subcategory 1422 provides documents relating to any major diagnosis in the field of immunodeficiency disorders, such as AIDS. Subcategory 1424 provides documents relating to any major diagnosis in the field of nephrology. Subcategory 1426 provides documents relating to any major diagnosis in the field of neurology. Subcategory 1428 provides documents relating to any major diagnosis in the field of pulmonary medicine. Subcategory 1430 provides documents relating to any major diagnosis in the field of rheumatology. Subcategory 1432 provides the patient's medical power of attorney, if any. Subcategory 1434 provides documents relating to any medications that are currently prescribed for the patient. Subcategory 1436 provides organ donor documents. Subcategory 1438 provides documents relating to the patients religion, and any restrictions on medical care that the patient's religion may impose on medical care. The advanced directive subcategory 1402 and the major diagnoses subcategories 1412-1430 may each have further layers of subcategories. The organization of information specifically for the emergency room, the inclusion of both medical and legal documents related to emergency care under the same category, and this illustrated pattern of organization of particular subcategories, in particular, are considered novel features of the invention.

The invention preferably includes a kit, provided to the client/patient, including a prepared USB device 1300 with a USB portable medical records database 1308 and security features 1304, 1306, 1308, 1312 and possibly 1314 previously mentioned, a bright red emergency wallet card as previously described, and a wallet or piece of jewelry for carrying the prepared USB device 1300.

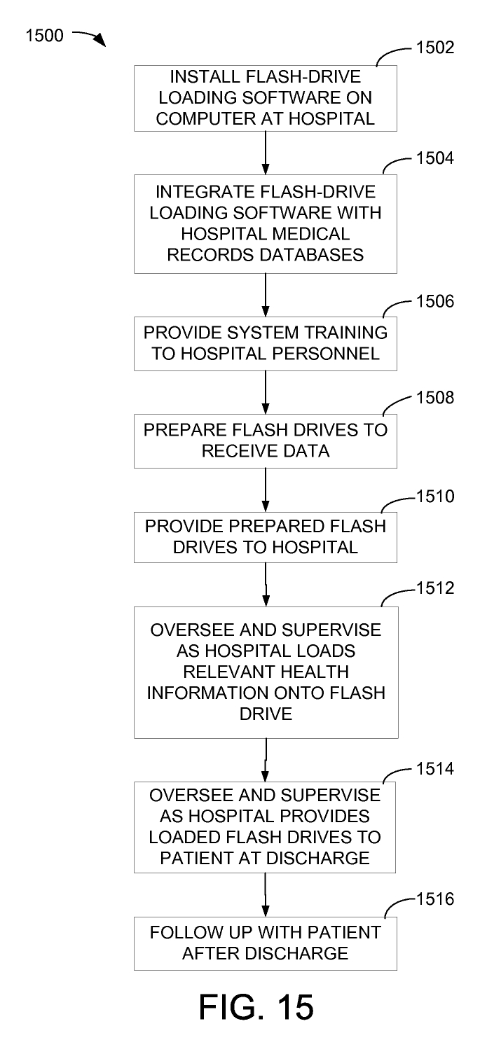

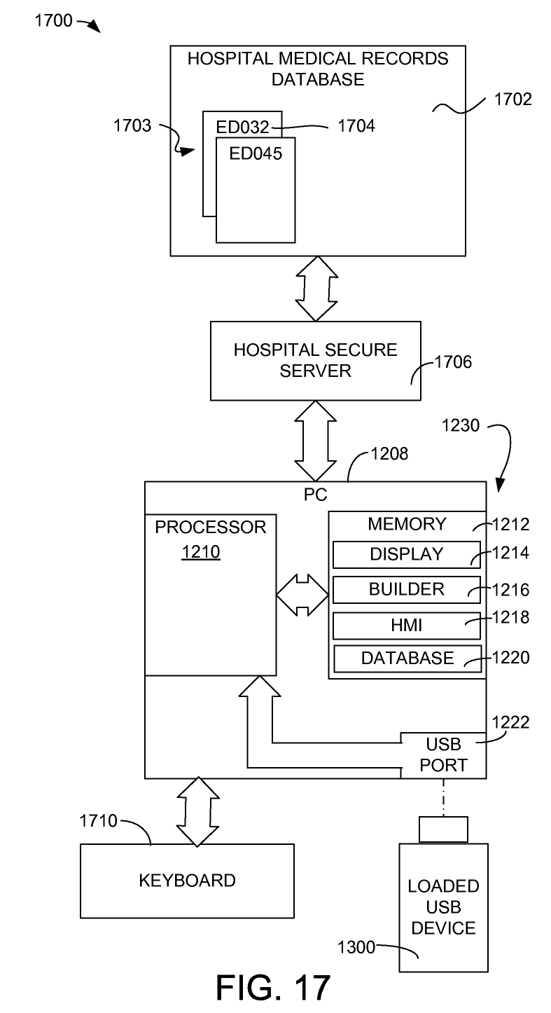

FIG. 15 is a process diagram illustrating an improved personal medical records system 1500, according to a preferred exemplary embodiment of the present invention. Improved personal medical records system 1500 is for use in a hospital. A first software 1320 is installed 1508 on each USB device 1226 to create prepared USB device 1300 and a second software 1230 is provided 1502 on a computer 1208 linked to a hospital computer 1706 that provides access to the hospital's medical records databases 1702 (see FIG. 17).

Second software 1230 is for retrieving, sorting, and securely loading, or storing, medical records data on the prepared USB device 1300, or flash drive, and is preferably provided 1502 on a computer 1208 that is linked to a hospital secure server 1706. Preferably, the secure server 1706 and the computer 1208 are located in the hospital, but the invention is not so limited. Second software 1230, or flash-drive-loading software, is integrated 1504 with the hospital's medical record databases 1702 on or through the secure server 1706 to provide access to the medical records 1702. Second software 1230 has customizable interfaces for integrating 1504 with various commercial medical records databases. Customization of the interfaces is part of the integration 1504 of second software 1230. The medical records retrieved include one or more documents 1703, each of which includes one or more unique document identifiers 1704. The documents 1703 are sortable into at least one predetermined category responsive to a document identifier 1704 and to a patient identifier of a particular patient. The sorted documents 1703 are each thereafter associated with the at least one category and the particular patient associated with the patient identifier.

After integration 1504, the second software 1230 can be used to retrieve medical records from the hospital medical records database 1702. The retrieved medical records are in the form of documents 1703 that each has at least one unique document identifier 1704. The unique document identifier 1704 may be used to assist in sorting the documents, for example, by report type. The documents 1703 may also be sorted, using the second software 1230, by patient identifier (data within the document) or metadata (data about the data). Predetermined categories may be provided, such as an emergency medicine category 1401, which may serve both as a sorting criterion and as a scheme of organization for the documents 1703 stored on the prepared USB device 1300.

The documents 1703 retrieved and stored in the prepared USB device 1300 are preferably documents 1703 authored by physicians. In a particular highly preferred embodiment, only documents 1703 that are actually dictated by physicians are retrieved by second software 1230 and stored in prepared USB device 1300, thus ensuring that other physicians may reasonably rely on the data in the prepared USB device 1300.

Once the second software 1230 is integrated 1504 with the hospital records databases, training 1506 is provided for use of the second software 1230 for storing documents authored by physicians in the prepared USB device 1300. Training 1506 includes initial training, continuing education, as well as test and verification. Training is not provided for each prepared USB device 1300 to be provided to the hospital, but is provided to create and maintain a competent work force.

The business is preferably separate from the hospital. In some embodiments, the hospital personnel that receive training may be subcontractors to the hospital. In some of those embodiments, the subcontractors may be from a company associated with the business.

The first software 1320 package, comprising auto-run program 1302, 256-bit encryption program 1304, six-failure auto-delete program 1306, display software 1310, at least one password access program 1312 or 1314, and a data structure, such as database 1308, preferably packaged as a single first software 1320 package, is provided for preparing 1508 USB devices 1226, or flash drives 1226, for use as part of the improved personal medical records system 1500. In a particular embodiment, second software 1230 includes a database program 1308 operable to enable updating of the medical record stored in the USB device 1226. In another particular embodiment, first software 1320 includes a database 1308 that must be rebuilt outside the USB device 1226 when a document 1703 (see FIG. 17) is to be added to the database 1308.

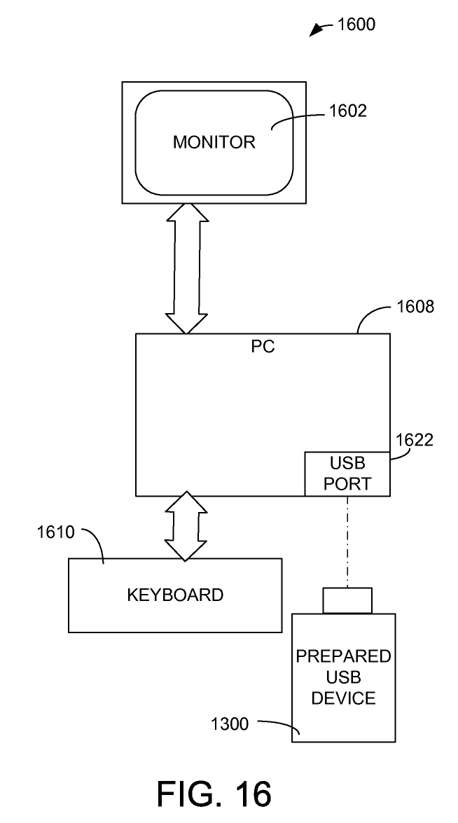

First software 1320 comprises software operable to provide password-protected access 1302 to the at least one document stored in the prepared USB device 1300, provide 256-bit encryption 1304 of the at least one document stored in the prepared USB device 1300, provide automatic deletion 1306 of the at least one document from the prepared USB device 1300 after six consecutive failed password attempts, and display 1310 the at least one document 1703 stored in said prepared USB device 1300 on a computer monitor 1602 (see FIG. 16), when the prepared USB device 1300 is coupled to a USB port 1622 associated with the computer monitor 1602, and responsive to entry of at least one password 1312, 1314 via keyboard 1610 or other input device. The first software 1320 provides data structure, such as database 1308; security, such as 256-bit encryption 1304, six-failure auto-delete 1306, and passwords 1312 and 1314; and display functions, including auto-run 1302 and display 1310. The first software 1320 display function 1310 enables a user to display documents by selecting a category, the first software 1320 responding by displaying all documents, perhaps in a cascaded format, that are associated with that category. Preferably, one category is an emergency medicine category 1401.

The first software 1320 prepares 1508 the USB device 1226 by being installed and tested in the USB device 1226, preferably at a facility outside of the hospital. In an alternate embodiment, the first software 1320 may be installed and tested in the hospital. The data structure, such as database 1308, may provide at least one category that is uniquely accessible. For example, emergency medicine 1401 documents may be accessible more rapidly than documents in general, either by a shortened or generic confidential password used by the hospital.

After preparation 1508 of the prepared USB device 1300, the prepared USB devices 1300 are provided 1510 to the hospital. Preferably, the hospital is charged a fee for the improved personal medical records system 1500 based on the number of prepared USB devices 1300 that are provided 1510 to the hospital.

The business implementing the improved personal medical records system 1500 oversees and supervises 1512 hospital personnel as the system 1500 begins operation. Oversight and supervision includes deficiency reporting and resolution both for procedures and software. The amount of oversight and supervision 1512 is adjusted to economical levels, depending on the error rate experienced. Software upgrades are implemented as they become available.

The business implementing the improved personal medical records system 1500 also oversees and supervises 1514 the delivery of the prepared USB device 1300, or flash drive, to the patient at discharge, preferably as part of a kit that includes an emergency information card and a wallet or piece of jewelry for assisting the client in carrying the prepared USB device 1300. The business also arranges a follow-up appointment 1516 between the patient and a representative of the business after discharge of the patient. The follow-up appointment 1516 provides an opportunity for the patient to subscribe to a service for updating their personal medical records with documents from their primary care physician or specialists. Subscriptions are another approach to earning fees for the business. Finally, in step 1516, the business implementing the improved personal medical records system 1500 verifies that the patient has provided the stored documents to the patient's primary care physician.

FIG. 16 is a block diagrammatic view illustrating the loaded USB device 1300 of the improved personal medical record system 1500 of FIG. 1 being used in a personal computer 1608. Loaded USB device 1300 is inserted into USB port 1622. Auto-run program 1302 then executes to bring up a password screen. The password 1312 is entered on keyboard 1610 or other input device. Access is granted to the database 1308 on the loaded USB device 1300 and the display software 1310 presents documents 1703 on monitor 1602 or similar display device.

FIG. 17 is a block diagrammatic view illustrating an implementation of the improved personal medical record system 1500 of FIG. 1, according to an exemplary embodiment of the present invention. Computer 1208 has second software 1230 installed, as discussed in more detail in regard to FIG. 12. Prepared USB device 1300 may be inserted into USB port 1222. Hospital personnel, using an input device such as keyboard 1710 and using HMI 1218, execute the database program 1220 and retrieve and sort documents 1703 from hospital medical records database 1702 through hospital computer 1706. Sorting may be accomplished using unique identifiers 1704 and a particular patient's identifier. The retrieved, sorted documents 1703 are then built into a database 1308 using builder software 1216 and installed on prepared USB device 1300.

FIG. 18 is a process diagram illustrating an improved personal medical records system 1800, according to a preferred exemplary embodiment of the present invention. Improved personal medical records system 1800 is for use in a hospital. A first software 1320 is provided 1802 for providing database and security on USB devices 1226. USB devices 1226 are prepared 1804 by installing first software 1320 on each USB device 1226 to create prepared USB devices 1300. The prepared USB devices 1300 are provided 1806 to the hospital and the business collects 1808 a fee from the hospital based on the number of prepared USB devices 1300 provided to the hospital.

A second software 1230 is provided 1810 for retrieving, sorting, and securely storing medical records data onto prepared USB devices 1300. Second software 1230 is installed on a computer 1208 linked to a hospital computer 1706 that provides access to the hospital's medical records databases 1702 (see FIG. 17). Second software 1230 is for retrieving, sorting, and securely loading, or storing, medical records data on the prepared USB device 1300, or flash drive, and is preferably installed 1812 on a computer 1208 that is linked to a hospital secure server 1706. Preferably, the secure server 1706 and the computer 1208 are located in the hospital, but the invention is not so limited. Second software 1230, or USB-device-loading software 1230, is installed 1812 with the hospital's medical record databases 1702 on or through the secure server 1706 to provide access to the medical records 1702. Second software 1230 has customizable interfaces for integrating 1504 with various commercial medical records databases. Customization of the interfaces is part of the integration 1504 of second software 1230. The medical records retrieved include one or more documents 1703, each of which includes one or more unique document identifiers 1704. The documents 1703 are sortable into at least one predetermined category responsive to a document identifier 1704 and to a patient identifier of a particular patient. The sorted documents 1703 are each thereafter associated with the at least one category and the particular patient associated with the patient identifier.

After installation 1812, the second software 1230 can be used to retrieve medical records from the hospital medical records database 1702. The retrieved medical records are in the form of documents 1703 that each has at least one unique document identifier 1704. The unique document identifier 1704 may be used to assist in sorting the documents, for example, by report type. The documents 1703 may also be sorted, using the second software 1230, by patient identifier (data within the document) or metadata (data about the data). Predetermined categories may be provided, such as an emergency medicine category 1401, which may serve both as a sorting criterion and as a scheme of organization for the documents 1703 stored on the prepared USB device 1300.

The documents 1703 retrieved and stored in the prepared USB device 1300 are preferably documents 1703 authored, preferably by dictation, by physicians. In a particular highly preferred embodiment, only documents 1703 that are actually dictated by physicians are retrieved by second software 1230 and stored in prepared USB device 1300, thus ensuring that other physicians may reasonably rely on the data in the prepared USB device 1300.

Once the second software 1230 is installed 1812 to work with the hospital records databases, the business trains 1814 hospital personnel in the use of the second software 1230 for storing documents authored by physicians in the prepared USB devices 1300. Training 1814 includes initial training and continuing education, as well as test and verification. Training is not provided for each prepared USB device 1300 to be provided to the hospital, but is provided to create and maintain a competent work force.

The business is preferably separate from the hospital. In some embodiments, the hospital personnel that receive training may be subcontractors to the hospital. In some of those embodiments, the subcontractors may be from a company associated with the business.

The first software 1320 package, comprising auto-run program 1302, 256-bit encryption program 1304, six-failure auto-delete program 1306, display software 1310, at least one password access program 1312 or 1314, and a data structure, such as database 1308, preferably packaged as a single first software 1320 package, is provided for preparing 1804 USB devices 1226 for use as part of the improved personal medical records system 1800. In a particular embodiment, second software 1230 includes a database program 1308 operable to enable updating of the medical record stored in the USB device 1300. In more preferred embodiment, first software 1320 includes a database 1308 that must be rebuilt outside the USB device 1226 when a document 1703 (see FIG. 17) is to be added to the database 1308.

First software 1320 comprises software operable to provide password-protected access 1302 to the at least one document stored in the prepared USB device 1300, provide 256-bit encryption 1304 of the at least one document stored in the prepared USB device 1300, provide automatic deletion 1306 of the at least one document from the prepared USB device 1300 after six consecutive failed password attempts, and display 1310 the at least one document 1703 stored in said prepared USB device 1300 on a computer monitor 1602 (see FIG. 16), when the prepared USB device 1300 is coupled to a USB port 1622 associated with the computer monitor 1602, and responsive to entry of at least one password 1312, 1314 via keyboard 1610 or other input device. The first software 1320 provides data structure, such as database 1308; security, such as 256-bit encryption 1304, six-failure auto-delete 1306, and passwords 1312 and 1314; and display functions, including auto-run 1302 and display 1310. The first software 1320 display function 1310 enables a user to display documents by selecting a category, the first software 1320 responding be displaying all documents, perhaps in a cascaded format, that are associated with that category. Preferably, one category is an emergency medicine category 1401.

The first software 1320 prepares 1804 the USB device 1226 by being installed and tested in the USB device 1226, preferably at a facility outside of the hospital. In an alternate embodiment, the first software 1320 may be installed and tested in the hospital.

The data structure, such as database 1308, may provide at least one category that is uniquely accessible. For example, emergency medicine 1401 documents may be accessible more rapidly than documents in general, either by a shortened or generic confidential password used by the hospital.

After preparation 1804 of the prepared USB device 1300, the prepared USB devices 1300 are provided 1806 to the hospital. Preferably, the business collects 1808 a fee from the hospital for the improved personal medical records system 1800 based on the number of prepared USB devices 1300 that are provided 1806 to the hospital.

The business implementing the improved personal medical records system 1800 oversees and supervises 1816 hospital personnel as the system 1800 begins operation. Oversight and supervision 1816 includes deficiency reporting and resolution both for procedures and software. The amount of oversight and supervision 1816 is adjusted to economical levels, depending on the error rate experienced. Software upgrades are implemented as they become available.

The business implementing the improved personal medical records system 1800 also oversees and supervises 1818 the delivery of the prepared USB device 1300 to the patient at discharge, preferably as part of a kit that includes an emergency information card and a wallet or piece of jewelry for assisting the client in carrying the prepared USB device 1300. The business also verifies 1820 that the patient's primary care physician receives a copy of the new medical records after discharge of the patient.

FIG. 19 is a process diagram further illustrating some salient features of an improved personal medical records system, according to a preferred exemplary embodiment of the present invention. A separate computer 1208 has database builder software 1216 and is communicatively coupled to hospital records source computer 1706 having access to medical records database 1702. Database builder software 1216 acquires records from the medical records database 1702 and builds a portable database 1308 and installs it into the USB device 1300. USB device 1300 also has security software 1304, 1306, 1312, and 1314; auto-run software 1302; and display software 1310 installed. The USB device 1300 has no resident data acquisition software, and so cannot be modified except through a computer 1208. USB device 1300 may then be used to display the stored data on display terminal 1608. The second software 1230 includes a database program 1220 that enables updating, 121, 221, 321, of the medical records stored in the prepared USB device 1300 by the process of: reading out the medical records from the prepared USB device 1300; rebuilding the database with a combination of the read-out medical record and additional documents; and storing the rebuilt database in the prepared USB device 1300.

FIG. 20 is a process diagram of some salient common features of the prior art disclosure of Lubell, including Lubell '884, Lubell '904, and Lubell '905, discussed more fully in the BACKGROUND section. Lubell's USB device 2008 has all the software, including database interface and communication software resident on the portable USB device 2008. Thus, the software for obtaining medical records or other data from any of various sources 2006 is portable, and accessible to the patient. This contrasts with the present invention, which does not have data acquisition software resident on the portable USB device 1300. Any PC may become a display and modification terminal 2010 using Lubell. Those of skill in the art are aware that nothing is “tamper proof” to a smart hacker with no time constraints. The present invention, by not delivering data acquisition software into the hands of potential hackers, reduces the risk of software and data compromise relative to Lubell.

FIG. 21 is a process diagram of some salient features of the prior art disclosure of Wilkins discussed more fully in the BACKGROUND section. Wilkins discloses a computer 2107 with formatting software that receives records from various sources 2106 and stores formatted records on portable device 2108. Wilkins discloses no security against access by medical, insurance, or emergency care providers. Wilkins does not expressly state where the software is resident, but suggests (Column 4, lines 40-45) that the software is resident on each computer used to record or view data. Thus, even the security features are apparently on the receiving computer of Wilkins, and no software is resident on the portable device 2108. This is distinct from the present invention.

FIG. 22 is a process diagram of some salient features of the prior art disclosure of Rothschild, discussed more fully in the BACKGROUND section. Rothschild provides full patient access to files gathered from various sources 2206. Viewer software is resident on Rothschild's portable device 2208 as is security software and a relational database that may be updated from any terminal 2210, as distinct from the present invention.

FIG. 23 is a process diagram of some salient features of the prior art disclosure of Hartman '131, discussed more fully in the BACKGROUND section. Hartman '131 has data acquisition software resident on his portable device 2308, as distinct from the present invention. Any terminal 2310 into which the portable device 2310 is inserted may be used to modify data on the portable device 2308, as distinct from the present invention. Hartman '131 creates a program product in a centralized records repository 2306 that is then installed on the portable device 2308. Hartman '131's combination of data acquisition software, decryption, and communications software creates a vulnerability to a hacker posing as a client and having unlimited time to access and modify the data acquisition program and device security features for purposes not originally intended. While Hartman '131′ clearly intends that the data acquired by the device resident software will only be stored in a third area of the device memory, those of skill in the art are aware that nothing is “tamper proof” to a smart hacker with no time constraints. The present invention, by not delivering the data acquisition software into the hands of potential hackers, reduces the risk of software and data compromise relative to Hartman '131. Hartman '131 discloses security methods to prevent changing the information stored on the device, but no security restrictions on reading the data: anyone in possession of the device and a personal computer can read all the confidential information.

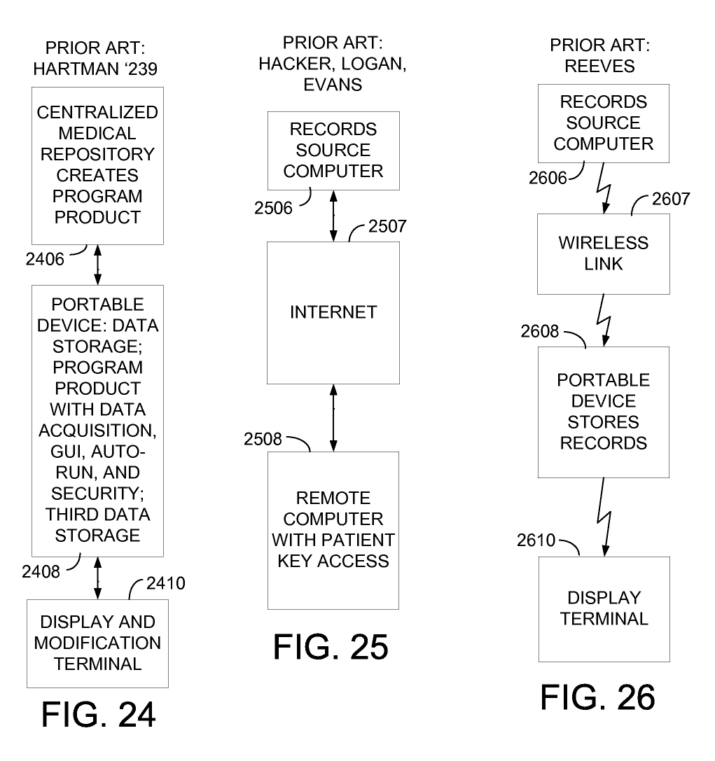

FIG. 24 is a process diagram of some salient features of another prior art disclosure of Hartman '239, discussed more fully in the BACKGROUND section. Hartman '239 has data acquisition software resident on his portable device 2408, as distinct from the present invention. Any terminal 2410 into which the portable device 2410 is inserted may be used to modify data on the portable device 2408, as distinct from the present invention. Hartman '131 creates a program product in a centralized records repository 2406 that is then installed on the portable device 2408, as distinct from the present invention. Hartman '239's combination of data acquisition software, decryption, and communications software creates a vulnerability to a hacker posing as a client and having unlimited time to access and modify the data acquisition program for purposes not originally intended. While Hartman '239′ clearly intends that the data acquired by the device resident software will only be stored in a third area of the device memory, those of skill in the art are aware that nothing is “tamper proof” to a smart hacker with no time constraints. The present invention, by not delivering data acquisition software into the hands of potential hackers, reduces the risk of software and data compromise relative to Hartman '239.

FIG. 25 is a process diagram of some salient common features of the prior art disclosures of Hacker, Logan, and Evans, discussed more fully in the BACKGROUND section. The disclosures of Hacker, Logan, and Evans are for centralized data repositories 2506 accessed over the internet 2507 by a patient using a remote computer 2508 with a personalized key. These are centralized, rather than distributed, data systems, and so are entirely distinct from the present invention.

FIG. 26 is a process diagram of some salient features of the prior art disclosure of Reeves, discussed more fully in the BACKGROUND section. Reeves presents a wireless portable device 2608 for storing records wirelessly received from a records source computer 2606 over a wireless link 2607. The records in the portable device 2608 may be down-linked to other display terminals 2610 for viewing. Reeves requires specialized terminals 2610 having wireless wands for reading data from the portable device 2608, as distinct from the present invention.

It should be appreciated that these exemplary embodiments are only examples, and are not intended to limit the scope, applicability, or configuration of the invention in any way. Rather, the foregoing detailed description will provide those skilled in the art with a convenient road map for implementing a preferred embodiment of the invention. It being understood that various changes may be made in the function and arrangement of elements described in an exemplary preferred embodiment without departing from the spirit and scope of the invention.

I claim:

1. An improved personal medical records system including a business method comprising the combination of steps of a business:
a. providing first software for providing at least one database and security on a USB device;
b. providing second software for retrieving, sorting, and securely storing medical records data onto said USB device;
c. installing said second software on a computer linked to a hospital computer system used for storing and managing at least one medical record wherein:
i. said at least one medical record comprises at least one document;
ii. said at least one document comprises at least one document identifier;
iii. said at least one document is sortable into at least one predetermined category responsive to said at least one document identifier and to a patient identifier of a particular patient; and
iv. said sorted at least one document is thereafter associated with said at least one category and such particular patient;
d. training hospital personnel to use said second software for securely storing said at least one document in said USB device;
e. preparing at least one said USB device by installing said first software onto said at least one said USB device;
f. providing said at least one prepared USB device to said hospital;
g. supervising such trained personnel of said hospital in storing said at least one document in said at least one prepared USB device, wherein said at least one document stored in said at least one database of said at least one prepared USB device comprises at least one document authored by at least one physician;
h. supervising such trained personnel of said hospital in providing to such particular patient, when such particular patient is discharged from said hospital, at least one discharge kit comprising:
i. said at least one prepared USB device having said stored at least one document;
ii. at least one emergency card providing emergency contact information and instructions for emergency use of said at least one prepared USB device; and
iii. at least one of a wallet and a piece of jewelry operable to assist in carrying said at least one prepared USB device and said at least one emergency card; and
i. verifying that such particular patient's primary care physician has received said at least one document.

2. The improved personal medical records system of claim 1, wherein said first software comprises software operable to:
a. provide password-protected access to said at least one document stored in said at least one prepared USB device;
b. provide 256-bit encryption of said at least one document stored in said at least one prepared USB device;
c. provide automatic deletion of said at least one document on said at least one prepared USB device after six consecutive failed password attempts; and
d. display, on a computer monitor, said at least one document stored in said at least one prepared USB device, responsive to entry of at least one password when said at least one prepared USB device is coupled to a USB port associated with said computer monitor.

3. The improved personal medical records system of claim 2, wherein said first software is further operable to display said at least one document responsive to selection, by a user of said computer, of said at least one category associated with said at least one document.

4. The improved personal medical records system of claim 3, wherein a particular category of said at least one category comprises an emergency medicine category and further wherein said emergency medicine category comprises a uniquely accessible category of said at least one document stored on said at least one prepared USB device.

5. The improved personal medical records system of claim 1, wherein said second software comprises software operable to:
a. retrieve, responsive to entry of such particular patient's said patient identifier, said at least one document associated with such particular patient from said hospital computer;
b. sort, responsive to said at least one document identifier and to said at least one predetermined category, said at least one document associated with such particular patient; and
c. store said at least one sorted document associated with such particular patient in said at least one database of said at least one prepared USB device.

6. The improved personal medical records system of claim 1, wherein said at least one prepared USB device comprises a plurality of prepared USB devices, said improved personal medical records system further comprising the step of charging a fee to said hospital based on the number of said plurality of prepared USB devices provided to said hospital.

7. The improved personal medical records system of claim 1, wherein said at least one document consists of at least one document created by dictation.

8. The improved personal medical records system of claim 1, further comprising the step of reviewing said at least one document for compliance with one of a medical standard and an insurance standard.

9. The improved personal medical records system of claim 1, wherein said training comprises at least one of:
a. initial training; and
b. continuing education;
c. wherein said training is not provided for each particular USB device to be provided.

10. The improved personal medical records system of claim 1, wherein said hospital personnel are subcontractors to said hospital.

11. The improved personal medical records system of claim 1, wherein said second software comprises a database program operable to enable updating of said at least one medical record stored in said at least one prepared USB device by the process of:
a. reading out said medical record from said at least one prepared USB device;
b. rebuilding said at least one database with a combination of said read-out medical record and additional documents; and
c. storing said at least one rebuilt database in said at least one prepared USB device.

12. The improved personal medical records system of claim 1, wherein:
a. said second software comprises software operable to build a USB database for said at least one document outside of said USB device;
b. said database built outside of said USB device comprises said at least one document previously stored on said USB device; and
c. said second software comprises software operable to store in said USB device said database built outside of said USB device.

13. An improved personal medical records system including a business method comprising the combination of steps of a business:
a. providing first software for providing at least one database and security on a USB device;
b. providing second software for retrieving, sorting, and securely storing medical records data onto said USB device;
c. installing said second software on a computer linked to a hospital computer system used for storing and managing at least one medical record wherein:
i. said medical records data comprise at least one document;
ii. said at least one document comprises at least one document identifier;
iii. said at least one document is sortable into at least one predetermined category responsive to said at least one document identifier; and
iv. said sorted at least one document is associated with said at least one category;
d. training hospital personnel to use said second software for securely storing said at least one document in said USB device, wherein:
i. said at least one document comprises at least one document associated with a particular patient's patient identifier; and
ii. said at least one document comprises at least one document dictated by at least one physician;
e. preparing at least one said USB device by installing said first software onto said at least one USB device;
f. providing said at least one prepared USB device to said hospital, wherein said training is not provided for each particular prepared USB device;
g. supervising such trained personnel of said hospital in storing said at least one document in said at least one prepared USB device;
h. supervising such trained personnel of said hospital in providing to such particular patient, when such particular patient is discharged from said hospital, at least one discharge kit comprising:
i. said at least one prepared USB device having said stored at least one document;
ii. at least one emergency card providing emergency contact information and instructions for emergency use of said at least one prepared USB device; and
iii. at least one of a wallet and a piece of jewelry operable to assist in carrying said at least one prepared USB device and said at least one emergency card; and
i. verifying that such particular patient's primary care physician has received said at least one document.

14. The improved personal medical records system of claim 13, wherein said first software comprises software operable to:
a. provide password-protected access to said at least one document stored in said USB device;
b. provide 256-bit encryption of said at least one document stored in said USB device;
c. provide automatic deletion of said at least one document on said USB device after six consecutive failed password attempts; and
d. display, when coupled to a USB port and responsive to entry of at least one password, said at least one document stored in said at least one prepared USB device.

15. The improved personal medical records system of claim 14, wherein said first software is further operable to display said at least one document responsive to user selection of said at least one category associated with said at least one document.

16. The improved personal medical records system of claim 15, wherein a particular category of said at least one category comprises an emergency medicine category and further wherein said emergency medicine category comprises a uniquely accessible category of said at least one document stored on said at least one prepared USB device.

17. The improved personal medical records system of claim 13, wherein said at least one prepared USB device comprises a plurality of prepared USB devices, said improved personal medical records system further comprising the step of charging a fee to said hospital based on the number of said plurality of prepared USB devices provided to said hospital.

18. The improved personal medical records system of claim 13, wherein said second software comprises software operable to:
a. retrieve, responsive to entry of such particular patient's said patient identifier, said at least one document associated with such particular patient from said hospital computer;
b. sort, responsive to said document identifiers and to said at least one predetermined category, said at least one document associated with such particular patient; and
c. store said at least one document associated with such particular patient in said at least one prepared USB device.

19. The improved personal medical records system of claim 13, further comprising the step of reviewing said at least one document for compliance with one of a medical standard and an insurance standard.

20. An improved personal medical records system including a business method comprising the combination of steps of a business:
a. providing first software for providing at least one database and security on a USB device;
b. providing second software for retrieving, sorting, and securely storing medical records data onto said USB device;
c. installing said second software on a computer linked to a hospital computer system used for storing and managing at least one medical record wherein:
i. said medical records data comprise at least one document;
ii. said at least one document comprises at least one document identifier;
iii. said at least one document is sortable into at least one predetermined category responsive to said at least one document identifier; and
iv. said sorted at least one document is associated with said at least one category;
d. training hospital personnel to use said second software for securely storing said at least one document in said USB device, wherein:
i. said at least one document comprises at least one document associated with a particular patient; and
ii. said at least one document consists of at least one document dictated by at least one physician;
iii. wherein said training comprises at least one of:
1. initial training; and
2. continuing education;
3. wherein said training is not provided for each particular USB device to be prepared;
e. preparing said USB device by installing said first software onto said at least one USB device;
f. providing a plurality of said prepared USB devices to said hospital and charging a fee to said hospital based on the number of prepared USB devices provided to said hospital;
g. supervising such trained personnel of said hospital in storing said at least one document in said prepared USB device;
h. supervising such trained personnel of said hospital in providing, to such particular patient when such particular patient is discharged from said hospital, at least one discharge kit comprising:
i. said at least one prepared USB device having said stored at least one document;
ii. at least one emergency card providing emergency contact information and instructions for emergency use of said at least one prepared USB device; and
iii. at least one of a wallet and a piece of jewelry operable to assist in carrying said at least one prepared USB device and said at least one emergency card; and
i. verifying that such particular patient's primary care physician has received said at least one document.
